(19) United States
(12) Patent Application Publication
(10) Pub. No.: US 2021/0339259 A1
(43) Pub. Date: Nov. 4, 2021

(54) PIPETTE TIP RACK ASSEMBLIES

(71) Applicant: BIOTIX, INC., San Diego, CA (US)

(72) Inventors: Arta MOTADEL, San Diego, CA (US); Peter Paul BLASZCAK, San Diego, CA (US)

(21) Appl. No.: 17/268,931

(22) PCT Filed: Aug. 27, 2019
(86) PCT No.: PCT/US2019/048354

§ 371 Date: Feb. 16, 2021

Related U.S. Application Data
(60) Provisional application No. 62/724,297, filed on Aug. 29, 2018.

(51) Int. Cl. B01L 9/00

(52) U.S. Cl. CPC B01L 9/543; B01L 2300/12

(57) ABSTRACT

Provided herein are pipette tip rack assemblies in which a plurality of pipette tip racks are contained within a transparent or translucent non-porous container. Also provided are methods for using and manufacturing pipette tip rack assemblies described herein.

### RELATED PATENT APPLICATIONS

This patent application is a 35 U.S.C. 371 national phase patent application of PCT/US2019/048354, filed on Aug. 27, 2019, entitled PIPETTE TIP RACK ASSEMBLIES, naming Arta Motadel and Peter Paul Blaszcak as inventors, and designated by attorney docket no. PEL-1032-PC, which claims the benefit of U.S. provisional patent application No. 62/724,297 filed on Aug. 29, 2018, entitled PIPETTE TIP RACK ASSEMBLIES, naming Arta Motadel and Peter Paul Blaszcak as inventors, and designated by Attorney Docket No. PEL-1032-PV. The entire content of the foregoing patent application is herein incorporated by reference for all purposes, including all text, tables and drawings.

### FIELD

The technology relates in part to pipette tip rack assemblies. The technology also relates in part to methods for manufacturing and using a pipette tip rack assembly described herein.

### BACKGROUND

Pipette tips are utilized in a variety of industries that have a requirement for handling fluids, and are used in facilities including medical laboratories and research laboratories, for example. In many instances pipette tips are used in large numbers, and often are utilized for processing many samples and/or adding many reagents to samples, for example.

Pipette tips often are substantially cone-shaped with an aperture at one end that can engage a dispensing device, and another relatively smaller aperture at the other end that can receive and emit fluid. Pipette tips generally are manufactured from a moldable plastic, such as polypropylene, for example. Pipette tips are made in a number of sizes to allow for accurate and reproducible liquid handling for volumes ranging from nanoliters to milliliters.

Pipette tips can be utilized in conjunction with a variety of dispensing devices, including manual dispensers (e.g., pipettors) and automated dispensers. A dispenser is a device that, when attached to the upper end of a pipette tip (the larger opening end), applies negative pressure to acquire fluids, and applies positive pressure to dispense fluids. The lower or distal portion of a dispenser (typically referred to as the barrel or nozzle) is placed in contact with the upper end of the pipette tip and held in place by pressing the barrel or nozzle of the dispenser into the upper end of the pipette tip. The combination then can be used to manipulate liquid samples.

Pipette tips can be shipped, stored and presented to a user or dispenser in racks. A plurality of pipette tip racks can be packaged as a unit.

### SUMMARY

Provided in certain aspects is an assembly that includes a transparent or translucent non-porous container in which a plurality of pipette tip racks is disposed as a unit. Each of the pipette tip racks generally includes a rack base, a pipette tip receptacle plate in connection with the rack base that includes an array of bores, and an array of pipette tips, where each pipette tips is inserted into a bore in the receptacle plate. Each of the pipette tip racks often includes a transparent or translucent lid in connection with the rack base. A non-porous container often includes a proximal member and a distal member. The proximal member and distal member of a container often are joined to one another, and optionally are sealed to one another, where a seal sometimes is an essentially air-tight seal. The interior of a container sometimes is essentially RNase free before and/or after the container is sealed, and sometimes the interior of the container provides a moisture-controlled environment when sealed. Pipette tip racks in the container sometimes are in a stacked arrangement. Pipette tip racks, or portion thereof, and/or pipette tips inserted into the bores of the receptacle plate(s) or portion thereof, sometimes are visible through the proximal member and/or the distal member of the non-porous container. A proximal member and/or a distal member of a container sometimes includes structural features configured to protect racks contained within a non-porous container from damage. In some aspects, such structural features include diagonally disposed ribs, horizontally disposed ribs, vertically disposed ribs, transition ribs and voids (e.g., crumple zones).

Also provided in certain aspects is a method for manufacturing an assembly described herein and methods for manufacturing one or more assembly components. Provided also in certain aspects are methods for using an assembly described herein, and methods for inventorying or identifying pipette tip racks and/or pipette tips in an assembly described herein.

Certain embodiments are described further in the following description, examples, claims and drawings.

### BRIEF DESCRIPTION OF THE DRAWINGS

The drawings illustrate certain embodiments of the technology and are not limiting. For clarity and ease of illustration, the drawings are not made to scale and, in some instances, various aspects may be shown exaggerated or enlarged to facilitate an understanding of particular embodiments.

FIG. 1 is a top perspective view of pipette tip rack assembly embodiment 100 (non-porous container containing medium pipette tip racks). FIG. 2 is bottom perspective view of pipette tip rack assembly embodiment 100. FIG. 3 is an exploded top perspective view of pipette tip rack assembly embodiment 100. FIG. 4 is a front view of embodiment 100. FIG. 5 is a back view of pipette tip rack assembly embodiment 100. FIG. 6 is a side view of pipette tip rack assembly embodiment 100. FIG. 7 is a top view of pipette tip rack assembly embodiment 100. FIG. 8 is a bottom perspective view of the container proximal member of pipette tip rack assembly embodiment 100. FIG. 9 is a bottom view of pipette tip rack assembly embodiment 100. FIG. 10 is a top perspective exploded view of embodiment 100 with the proximal member and distal member separated. FIG. 11 is a top perspective view of non-porous container embodiment 140 of assembly embodiment 100 with no pipette tip racks contained within and with the proximal member joined to the distal member.

FIG. 12 is a top perspective view of pipette tip rack assembly embodiment 200 (non-porous container containing tall pipette tip racks). FIG. 13 is a bottom perspective view of pipette tip rack assembly embodiment 200. FIG. 14 is an exploded top perspective view of pipette tip rack assembly embodiment 200. FIG. 15 is a front view of embodiment 200. FIG. 16 is a back view of embodiment 200. FIG. 17 is a side view of embodiment 200. FIG. 18 is a top view of pipette tip rack assembly embodiment 200. FIG. 19 is a bottom perspective view of a container proximal member embodiment 240 of pipette tip rack assembly embodiment 200. FIG. 20 is a bottom view of pipette tip rack assembly embodiment 200. FIG. 21 is a top perspective view of embodiment 200 in which the proximal member and distal member are separated. FIG. 22 is a top perspective view of the non-porous container 240 of assembly embodiment 200 with no pipette tip racks contained within and with the proximal member joined to the distal member.

Certain features illustrated in the drawings are described in the following table.

| Callout No. | Feature |
|---|---|
| 100 | pipette tip rack assembly (medium pipette tip rack) |
| 105 | pipette tip rack (medium) |
| 110 | rack base |
| 115 | distal surface of rack base |
| 120 | pipette tip receptacle plate (snap card) |
| 125 | bore |
| 130 | pipette tip |
| 135 | rack lid |
| 137 | proximal surface of rack lid |
| 140 | non-porous container (medium) |
| 141 | proximal member (shallow) |
| 142 | flange |
| 142-1 | peripheral flange proximal sidewall |
| 142-2 | peripheral flange distal sidewall |
| 142-3 | peripheral flange sidewall step |
| 142-4 | flange proximal rim |
| 142-5 | inside flange proximal sidewall |
| 142-6 | inside flange distal sidewall |
| 142-7 | inside flange sidewall step |
| 143 | lip |
| 145 | proximal member panel |
| 146-1 | flange inside long sidewall |
| 146-2 | flange peripheral long sidewall |
| 147-1 | flange inside short sidewall |
| 147-2 | flange peripheral short sidewall |
| 148, 148A, 148B | boss |
| 149 | tab |
| 150 | distal member of container (shallow) |
| 151 | distal member long sidewall |
| 152 | distal member short sidewall |
| 153 | distal member bottom panel |
| 154 | flange |
| 154-1 | flange sidewall |
| 154-2 | flange proximal surface |
| 155 | lip |
| 157 | optional volumetric graduation mark |
| 158 | distal member side panel |
| 159 | side panel undercut |
| 160 | non-porous container interior |
| 165 | non-porous container exterior |
| 170 | rib vh transition |
| 172 | peripheral rib (short side) |
| 173 | peripheral rib (long side) |
| 176 | horizontally disposed rib |
| 177 | diagonally disposed rib |
| 178 | vertically disposed rib |
| 179 | sidewall junction rib |
| 180 | sidewall junction rib transition |
| 181 | transition from distal flange inside sidewall to |
| | proximal member panel |
| 182, 182A, 182B | crumple zone |
| 205 | pipette tip rack (tall) |
| 210 | rack base |
| 215 | distal surface of rack base |
| 220 | pipette tip receptacle plate (snap card) |
| 225 | bore |
| 230 | pipette tip |
| 235 | rack lid |
| 237 | proximal surface of rack lid |
| 240 | non-porous container (tall) |
| 241 | proximal member of container (tall) |
| 242 | flange |
| 242-1 | flange sidewall |
| 242-2 | flange step |
| 243 | lip |
| 244 | proximal member side panel |
| 245 | proximal member top panel |
| 246 | flange long sidewall |
| 247 | flange short sidewall |
| 248 | vertically disposed rib |
| 249 | tab |
| 250 | distal member of container (deep) |
| 251 | distal member long sidewall |
| 252 | distal member short sidewall |
| 253 | distal member bottom panel |
| 254 | flange |
| 254-1 | flange sidewall |
| 254-2 | flange proximal surface |
| 255 | lip |
| 257 | optional volumetric graduation mark |
| 258 | distal member side panel |
| 259 | side panel undercut |
| 260 | non-porous container interior |
| 265 | non-porous container exterior |
| 270 | rib vh transition |
| 272 | peripheral rib (short side) |
| 273 | peripheral rib (long side) |
| 276 | horizontally disposed rib |
| 277 | diagonally disposed rib |
| 278 | vertically disposed rib |
| 279 | sidewall junction rib |
| 280 | sidewall junction rib transition |
| 281 | transition from distal flange inside sidewall to |
| | proximal member panel |
| 282, 282A, 282B | crumple zone |
| 301 | horizontal axis |
| 302 | vertical axis |

### DETAILED DESCRIPTION

Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

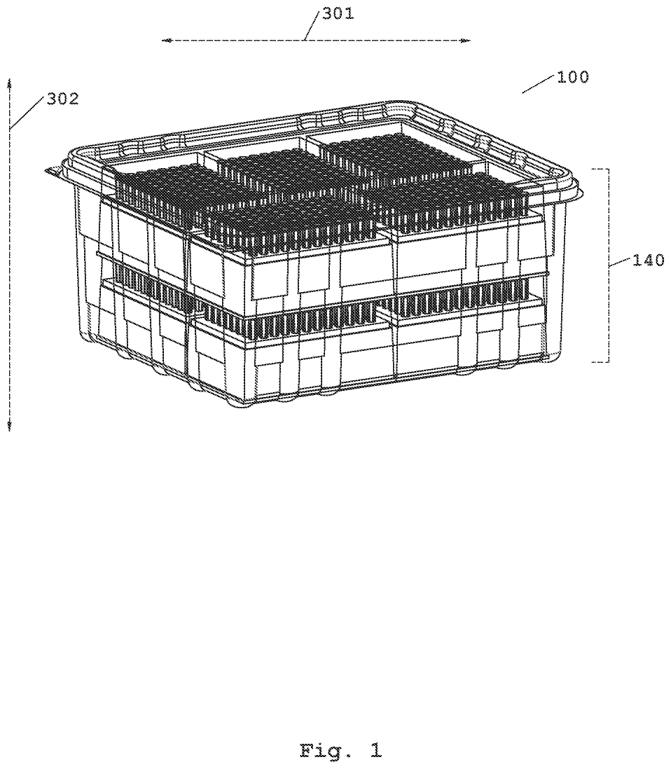

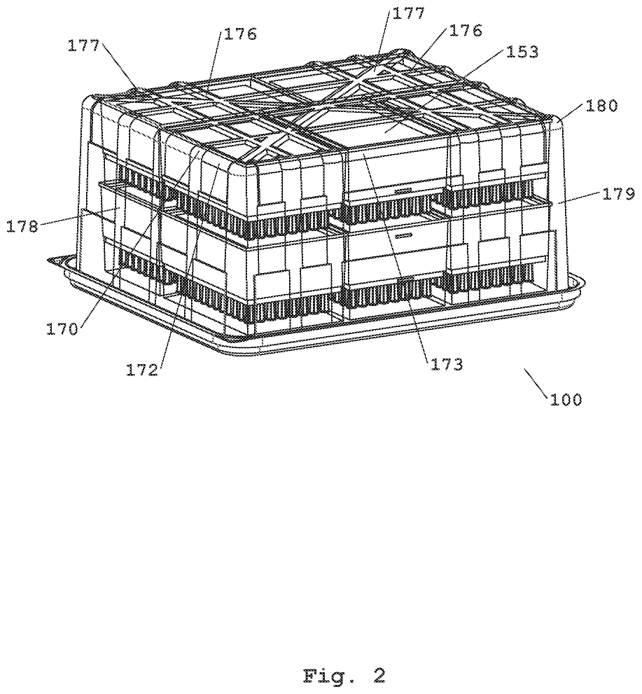

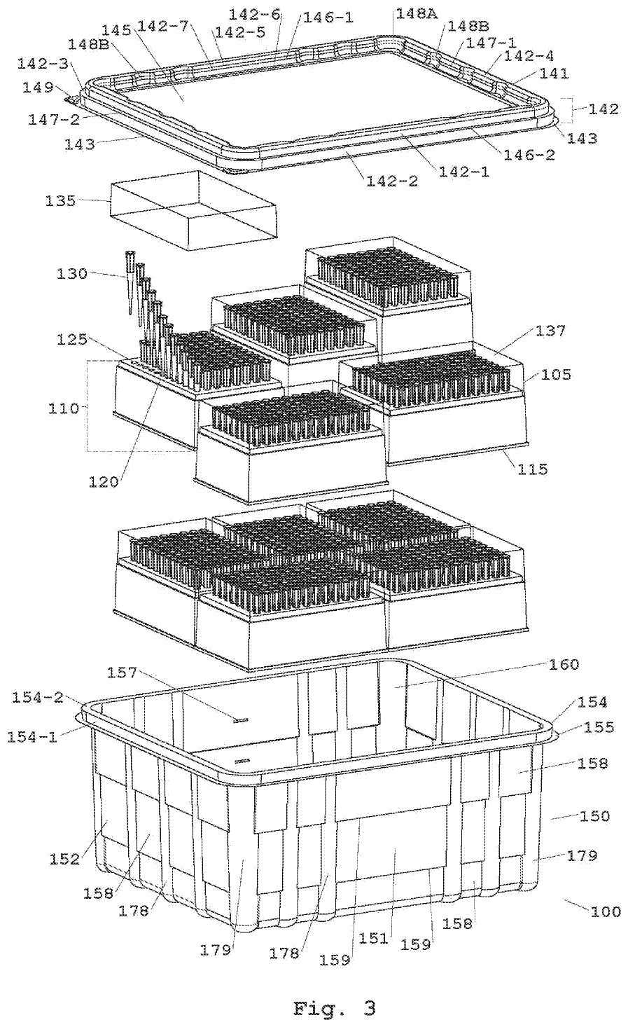

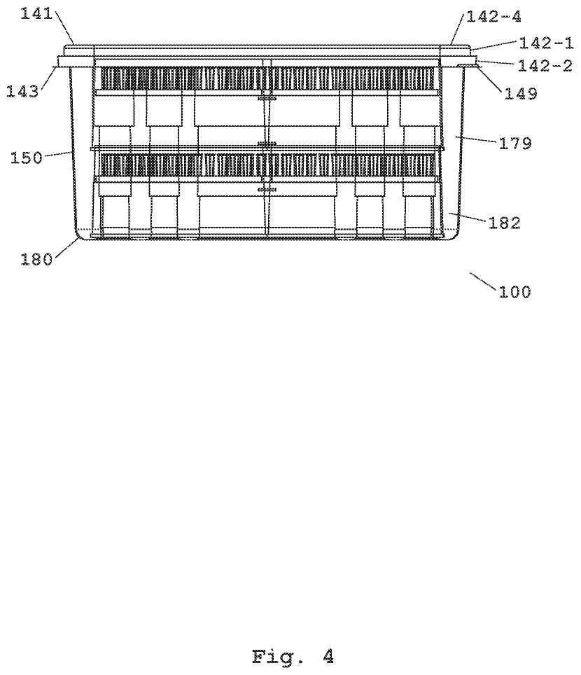

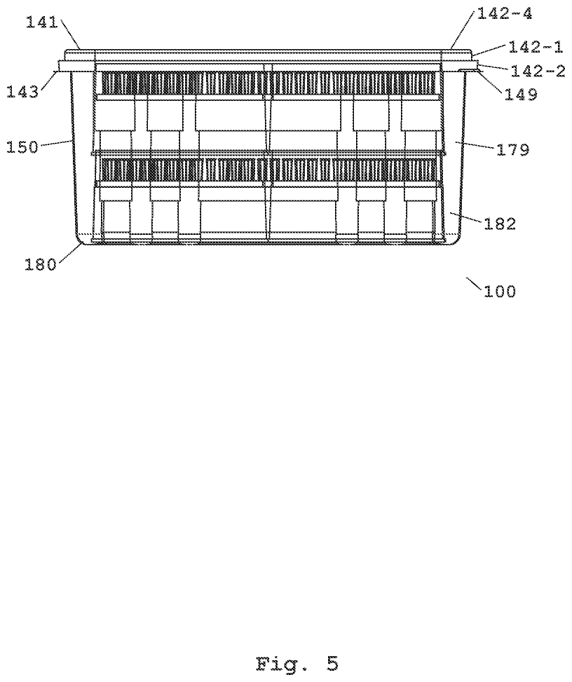

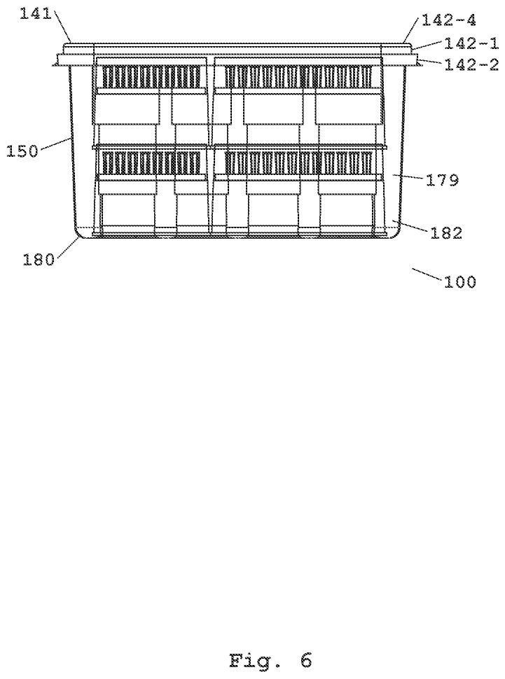

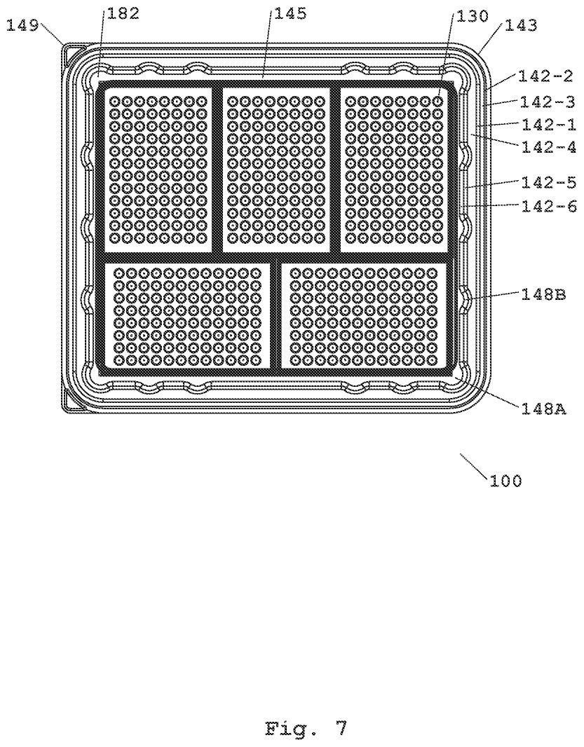

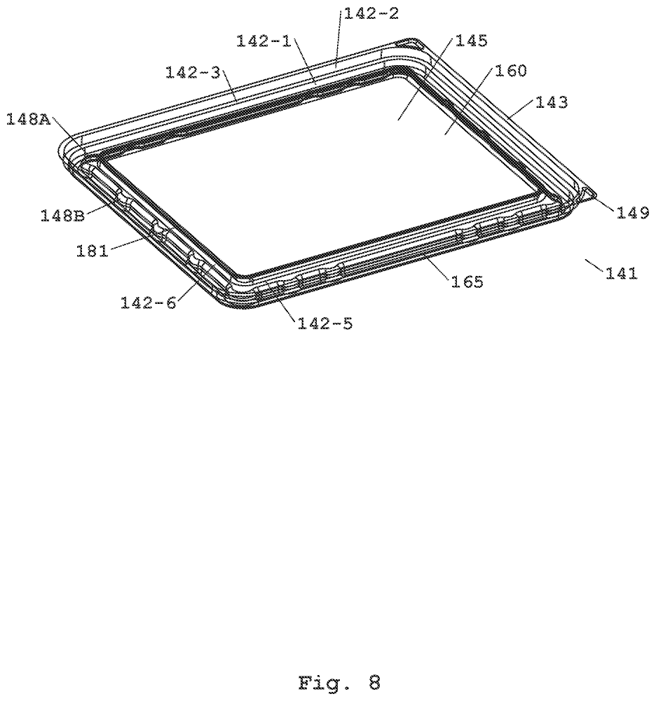

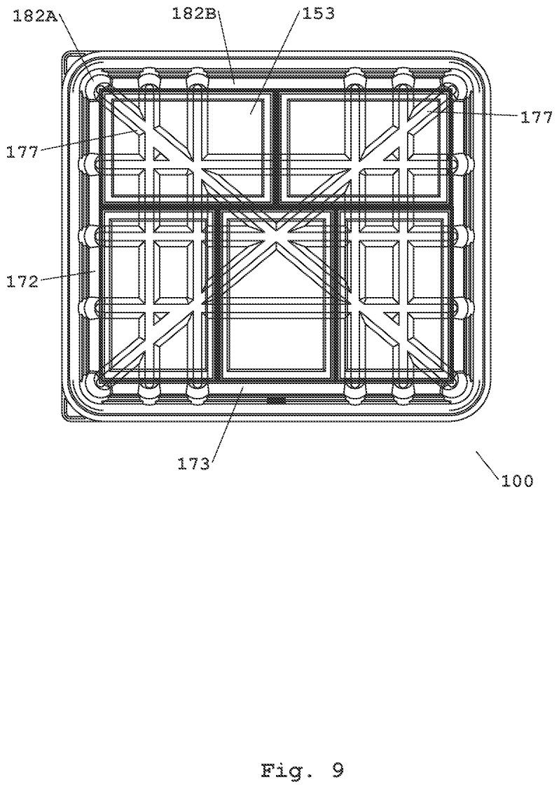

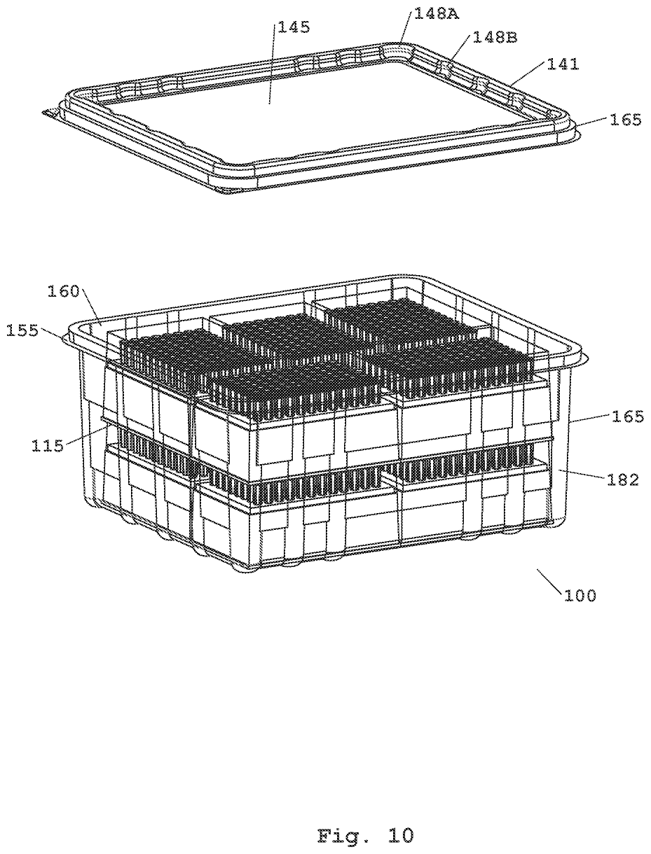

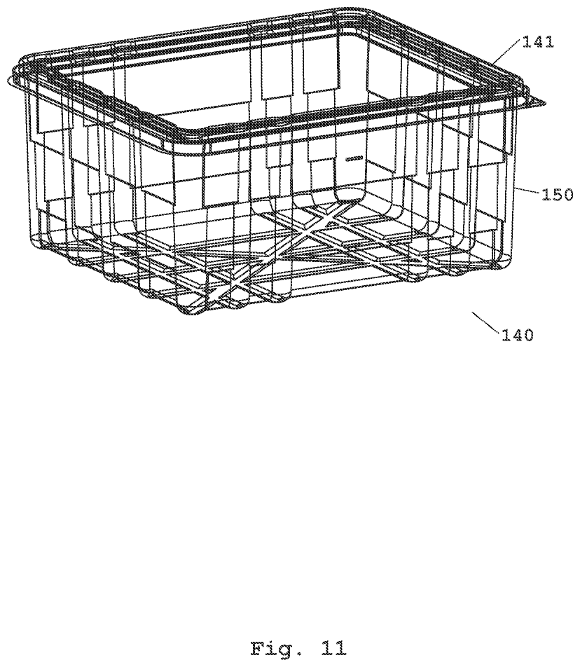

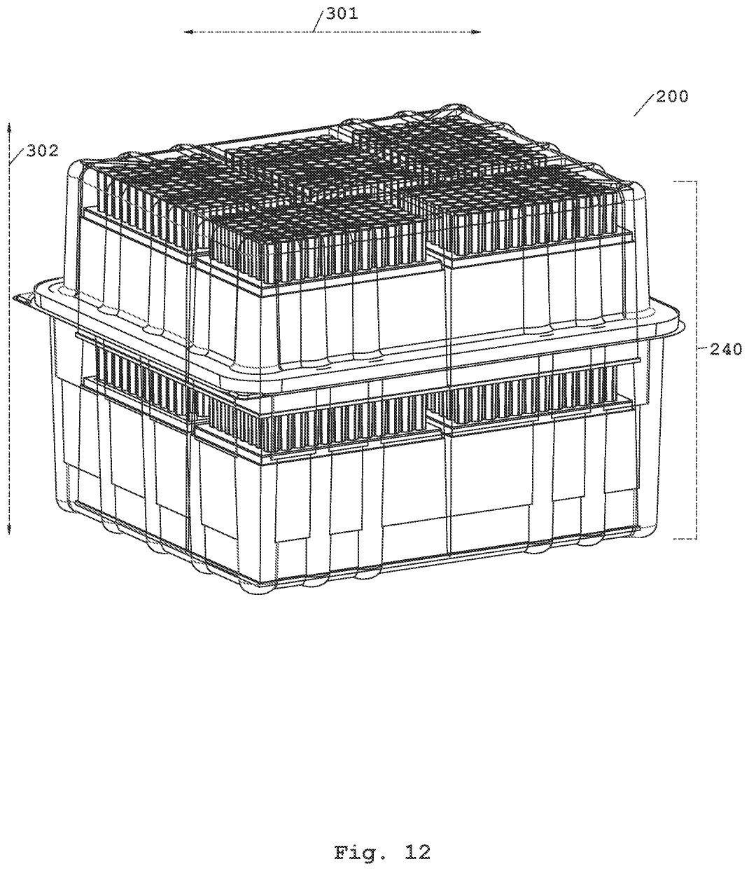

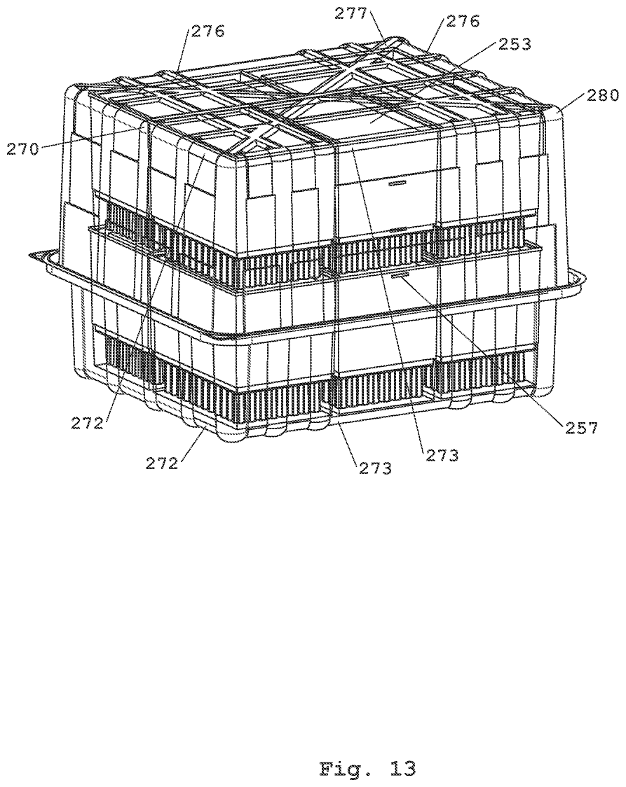

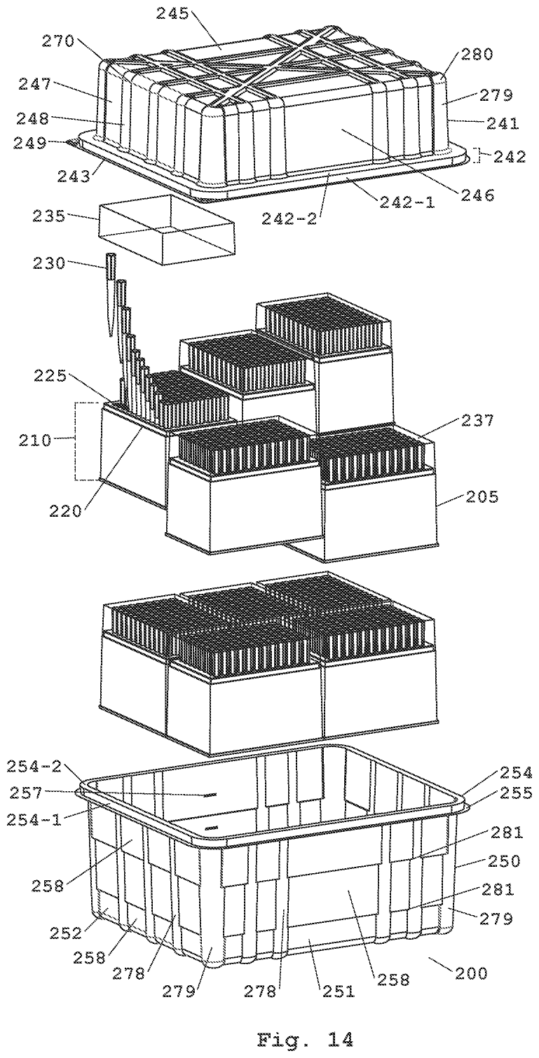

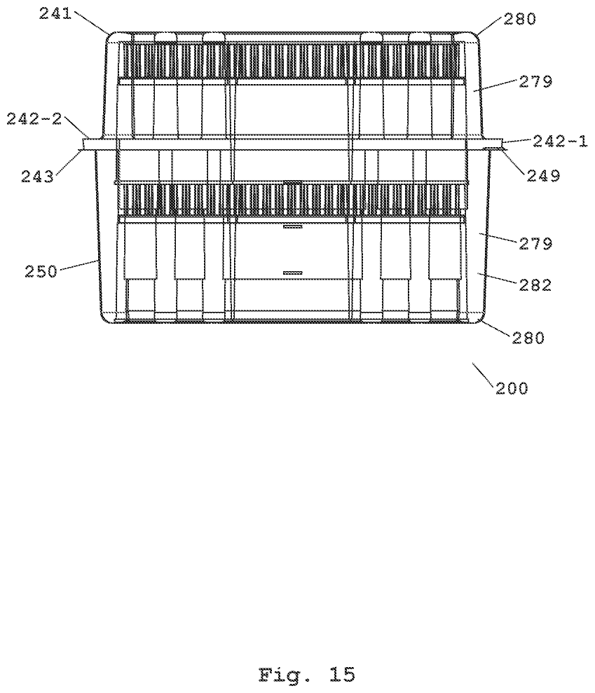

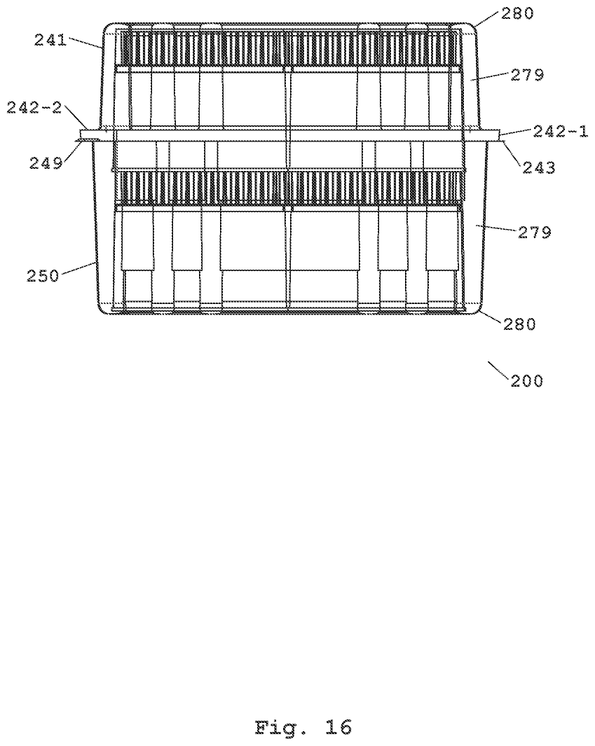

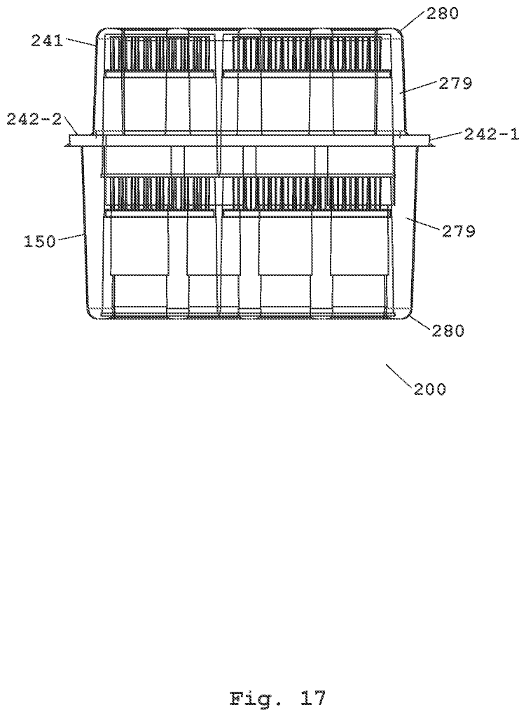

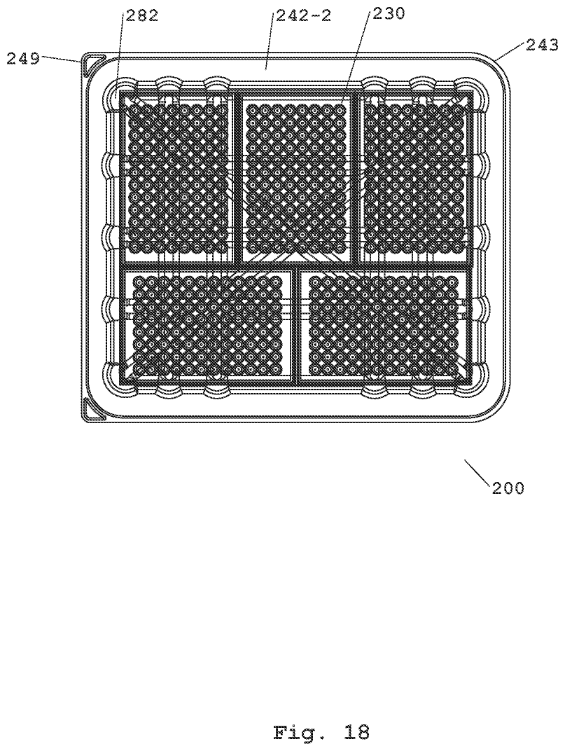

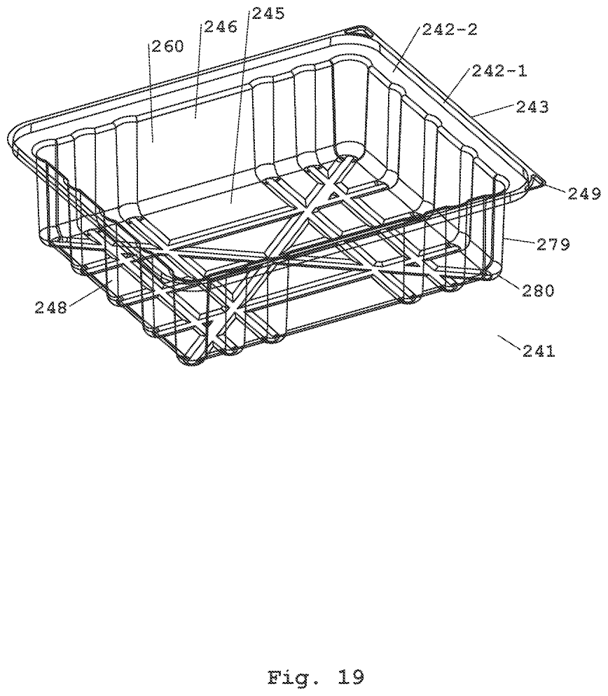

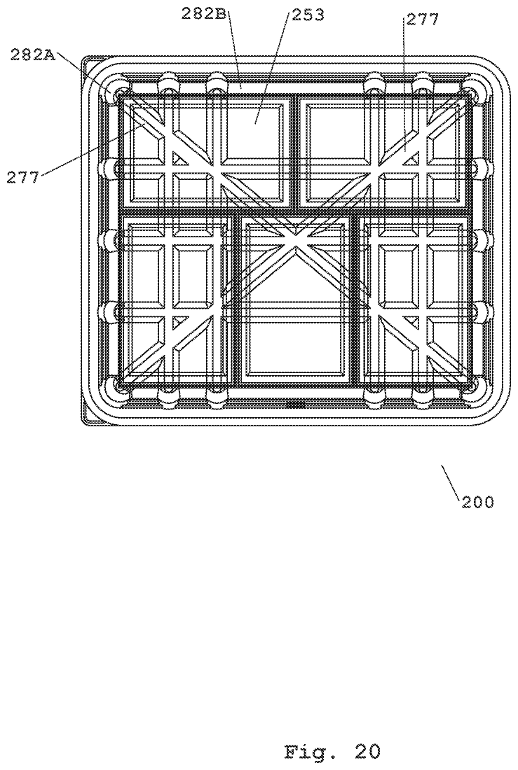

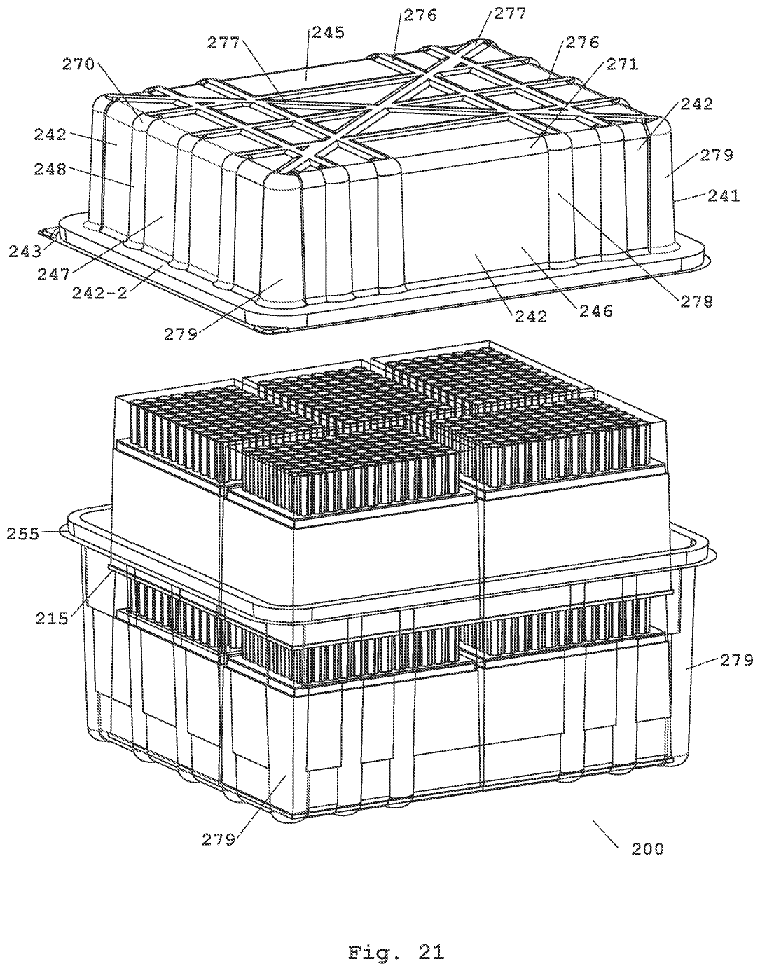

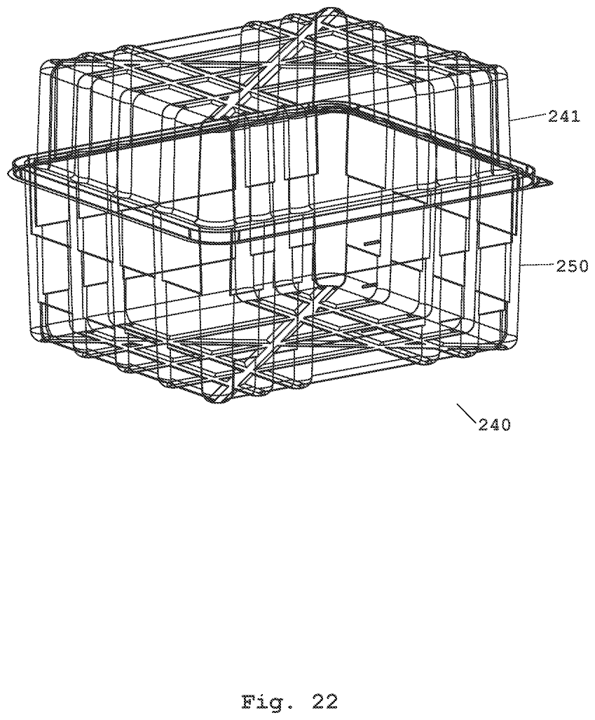

Described hereafter are certain non-limiting pipette tip rack assembly embodiments (e.g., embodiment 100 illustrated in FIG. 1 for medium height pipette tip racks and embodiment 200 illustrated in FIG. 12 for tall height pipette tip racks). In certain embodiments, provided are assemblies that include (i) a transparent or translucent non-porous container (e.g., container 140 illustrated in FIG. 11 and container 240 illustrated in FIG. 22) that includes a proximal member (e.g., proximal member 141 illustrated in FIG. 11 (shallow) and proximal member 241 illustrated in FIG. 22 (tall)) and a distal member (e.g., distal member 150 illustrated in FIG. 11 (shallow) and distal member 250 illustrated in FIG. 22 (deep)), and (ii) a plurality of pipette tip racks (e.g., pipette tip racks 105 illustrated in FIG. 3 (medium)) and pipette tip rack 205 illustrated in FIG. 14 (tall)) contained within. In certain embodiments, the proximal member and distal member are sealed and the seal sometimes is essentially air-tight.

Features of the pipette tip rack assemblies described herein confer multiple advantages. For example, the features can impart advantages in manufacturing, packing, shipping, storage, and use. Certain advantageous features of the technology are described hereafter.

### Pipette Tip Rack Assemblies

In some embodiments, one or more pipette tip racks are disposed in a non-porous container as a unit in an assembly (e.g. assembly 100 illustrated in FIG. 1 and assembly 200 illustrated in FIG. 12). Assemblies described herein allow for packaging of pipette tip racks in a clean, sterile, RNase free and moisture-controlled environment (i.e., within the interior of a non-porous container), and are useful for shipping, storing and using pipette tip racks. An assembly described herein also enables a user to dispense one or more pipette tip racks from a non-porous container and maintain the remainder of the racks in the non-porous container in a clean and sterile environment, as the non-porous container often can be resealed. In addition, an assembly described herein provides packaging that is inert and does not itself generate contaminants (e.g., does not generate particulate matter such as paper particles).

An assembly described herein also allows for enhanced visibility of pipette tip racks or portions thereof and/or pipette tips within a non-porous container through multiple transparent and/or translucent members of the container (see, e.g., “Multiple Views” section hereafter). In certain embodiments, a subset of portions, or the entirety, of a non-porous container is translucent or transparent. Enhanced visibility of racks and pipette tips eliminates the need for labelling on an outer surface of packaging to identify the packaged contents. In addition, tracking inventory of racks and pipette tips is facilitated as the number of racks within a non-porous container can be determined without the need to open the container. Also, visibility of racks and pipette tips through multiple transparent and/or translucent members of a non-porous container allows for different arrangements of pipette tip racks within a non-porous container and different storage configurations of non-porous containers, without compromising visibility of non-porous container contents.

In assemblies described herein, pipette tip racks can be packaged in a clean, sterile, RNase free and moisture-controlled environment (i.e., within the interior of a non-porous container) without the need to separately provide such conditions for each pipette tip rack. Packaging of multiple pipette tip racks in a non-porous container is more cost effective and environmentally friendly than single-use packaging that is discarded in whole or in part (e.g., cardboard non-porous containers that optionally are shrink-wrapped). The entire packaging unit (i.e., the non-porous container) can be reused to store items other than pipette tip racks, or can be recycled, for example, after all of the multiple pipette tip racks have been utilized.

Assemblies described herein also can facilitate quality control and can facilitate maintaining the integrity of pipette tip racks contained within a non-porous container. Damage to racks in a container often occurs at the edges or corners of the container. In some embodiments, the geometry of a non-porous container provided herein reduces or eliminates the probability of contact between a rack with an edge or corner of the container after the container is contacted with an impact force (i.e., a crumple zone). In such embodiments, a container sometimes includes one or more voids, at which an interior surface of a container is separated a particular distance from an adjacent exterior surface of a rack. A void region in such embodiments permits deformation of the container surface (e.g., resulting from an impact force) without the deformed container surface contacting an adjacent rack surface. In some embodiments, corners and/or edges of a non-porous container include one or more ribs, which impart structural rigidity (e.g., reinforced corners and/or edges), and reduce the degree of, or reduce the likelihood of, deformation of a container surface after contact with an impact force. In some embodiments, corners and/or edges of a non-porous container include intersecting ribs that impart structural rigidity (e.g., reinforced corners). In some embodiments, other surfaces of a non-porous container (e.g., sides, top and/or bottom) may also contain ribs that contribute to the integrity and impart structural rigidity to these other surfaces of the container, thereby reducing effects caused by an impact force.

Certain non-limiting features of assemblies described herein are shown in the drawings. FIG. 1 to FIG. 11 illustrate assembly embodiment 100 configured to contain medium-sized pipette tip racks (e.g., racks that store pipette tips capable of retaining and emitting volumes of about 1 to about 300 microliters or less). FIG. 12 to FIG. 22 illustrate assembly embodiment 200 configured to contain tall pipette tip racks (e.g., racks that store pipette tips capable of retaining and emitting volumes of about 1000 to about 1300 microliters or less). These embodiments are non-limiting as a non-porous container can be configured to accommodate any suitable pipette tip rack that stores pipette tips of a suitable size.

### Pipette Tip Racks

A pipette tip rack generally includes (i) a rack base (e.g., base 110 illustrated in FIG. 3 and base 210 illustrated in FIG. 14), (ii) a pipette tip receptacle plate (e.g., plate 120 illustrated in FIG. 3 and plate 220 illustrated in FIG. 14) that includes an array of bores (e.g., bore 125 illustrated in FIG. 3 and bore 225 illustrated in FIG. 14), and (iii) an array of pipette tips, where each pipette tip (e.g., pipette tip 130 illustrated in FIG. 3 and FIG. 7 and pipette tip 230 illustrated in FIG. 14 and FIG. 18) is inserted in a bore of the receptacle plate. A pipette tip receptacle plate can also be referred to as a “snap card.” In some embodiments, a pipette tip rack includes a detachable rack lid (e.g., 135 in FIGS. 3 and 235 in FIG. 14) in connection with a proximal portion of the rack base at the rack base perimeter. A rack lid typically is rectangular with four sidewalls (e.g., two long sidewalls and two short sidewalls) and often includes a proximal surface (i.e., top surface; e.g., proximal surface 137 illustrated in FIG. 3 and proximal surface 237 illustrated in FIG. 14).

In some embodiments, a rack lid is transparent or translucent and pipette tips inserted into the bores of the receptacle plate are visible through the sides and/or top of a rack lid in connection with a rack base. In some embodiments, a rack base is transparent or translucent and pipette tips inserted into the bores of the receptacle plate connected to a base are visible through the sides of the base. In some embodiments a rack base is opaque.

### Pipette Tips

A pipette tip rack generally includes an array of pipette tips, where each of the pipette tips in the array is disposed in a bore of a receptacle plate of the rack. A pipette tip array can include any useful number of pipette tips, which sometimes is a multiple of 96 tips (e.g., 96, 192, 288, 384, 576, 672, 768 or 1536). In some embodiments, a pipette tip array includes 96 tips. In some embodiments, a pipette tip array includes 384 tips.

Pipette tips often are substantially cone-shaped with an aperture at the proximal terminus that can engage a dispensing device, and another relatively smaller aperture at the distal terminus that can receive and emit fluid. Pipette tips generally are manufactured from a moldable plastic, such as polypropylene, for example. Pipette tips are made in a number of sizes to allow for accurate and reproducible liquid handling of volumes ranging from nanoliters to milliliters.

Pipette tips can be utilized in conjunction with a variety of dispensing devices, including manual dispensers (e.g., pipettors) and automated dispensers. A dispenser is a device that, when attached to the proximal terminus of a pipette tip (the larger opening end), applies negative pressure to acquire fluids, and applies positive pressure to dispense fluids.

Pipette tips can be of any overall geometry useful for dispensing fluids in combination with a dispensing device. Non-limiting examples of volumes that can be manipulated by a pipette tip in combination with a dispensing device include pipette tips configured in sizes that handle a volume of about 0.1 to about 10 microliters, about 0.1 to about 20 microliters, about 1 to about 100 microliters, about 1 to about 130 microliters, about 1 to about 200 microliters, about 1 to about 300 microliters, about 1 to about 1000 microliters, and about 1 to about 1300 microliters. In some embodiments, the volume a pipette tips described herein can manipulate is larger or smaller than the volume designation afforded to a particular pipette tip.

### Rack Base

A rack base (e.g., base 110 illustrated in FIG. 3 and base 210 illustrated in FIG. 14) often is substantially rectangular with four sidewalls (e.g., two long sidewalls and two short sidewalls), a proximal surface (top) and a distal surface (bottom, e.g. distal surface 115 illustrated in FIG. 10 and distal surface 215 illustrated in FIG. 21). A junction at which a long sidewall and a short sidewall of a base meet sometimes is a rack short sidewall to long sidewall transition surface, which may include a sharp edge, rounded edge or beveled edge, for example. A rack base bottom can include a distal flange foot disposed at or near the distal surface of the rack, which can increase stability of the rack base. A rack base can include one or more structures that enhance stability of the rack base, including for example, interior cross members (e.g., shorter cross members and/or longer cross members) that increase stability of the rack base, and/or one or more sidewall structures (e.g., vertically-, horizontally- and/or diagonally-disposed ribs).

### Pipette Tip Receptacle Plate

A pipette tip receptacle plate (e.g., plate 120 illustrated in FIG. 3 and plate 220 illustrated in FIG. 14) generally includes a proximal surface, a distal surface, and an array of bores extending from the proximal surface to the distal surface, where each bore in the array of bores generally is configured to receive a pipette tip. An array of bores can have any useful number of bores, which sometimes is a multiple of 96 bores (e.g., 96, 192, 288, 384, 576, 672, 768 or 1536). An array or bores can be any suitable two-dimensional array, such as an X by Y array of bores, where X independently is about 2 to about 1,000 bores and Y independently is about 2 to about 1,000 bores (e.g., an 8 by 12 array; 16 by 24 array). An array of bores often includes a regularly spaced set of bores, where the vertical axis extending through each bore is spaced equally from other vertical axes (e.g., center-to-center distance of about 9 millimeters for 96 bore plates). A pipette tip receptacle plate can include a raised surface that includes some or all of the pipette tip receptacle plate bores. Portions of a pipette tip typically reside above the plate, are co-extensive with the thickness of the plate, and reside below the plate. A pipette tip often includes a step (e.g., shoulder) that determines the amount of the pipette tip disposed above the plate (e.g., a pipette tip collar resides above the plate having a shoulder in contact with the plate).

A pipette tip receptacle plate sometimes includes one or more fastener members that interact with counterpart fastener members in a rack base and serve to fasten the receptacle plate to the rack base. A pipette tip receptacle plate sometimes is referred to a “snap plate,” as in some embodiments, a plate can snap into the rack base when joining fastener members in the plate with fastener member counterparts in the rack base.

### Non-Porous Container

In some embodiments, pipette tip racks are packaged in a non-porous container (e.g., container 140 illustrated in FIG. 11 and container 240 illustrated in FIG. 22). Generally, a non-porous container includes a proximal member (e.g., proximal member 141 illustrated in FIG. 11 and proximal member 245 illustrated in FIG. 22) and a distal member (e.g., distal member 150 illustrated in FIG. 11 and distal member 250 illustrated in FIG. 14). A container often is a plastic container, for which a portion of the container or all of the container is manufactured from a plastic polymer, non-limiting examples of which are provided herein. A plastic container member (e.g., a proximal member, a distal member) often has a substantially uniform wall thickness (e.g., of all walls of the member, including sidewalls, flanges, lips and panels), and sometimes the wall thickness is about 0.002 inches to about 0.10 inches (e.g., about 0.003 inches, 0.004 inches, 0.005 inches, 0.006 inches, 0.007 inches, 0.008 inches, 0.009 inches, 0.010 inches, 0.015 inches, 0.020 inches, 0.025 inches, 0.030 inches, 0.035 inches, 0.040 inches, 0.045 inches, 0.050 inches, 0.055 inches, 0.060 inches, 0.065 inches, 0.070 inches, 0.075 inches, 0.080 inches, 0.085 inches, 0.090 inches, 0.095 inches). A substantially uniform wall thickness sometimes is defined by a variance of about 0.010 inches of less (e.g., variance of about 0.009 inches or less, 0.008 inches or less, 0.007 inches or less, 0.006 inches or less, 0.005 inches or less, 0.004 inches or less, 0.003 inches or less, 0.002 inches or less, 0.001 inches or less, 0.0009 inches or less, 0.0008 inches or less, 0.0007 inches or less, 0.0006 inches or less, 0.0005 inches or less, 0.0004 inches or less, 0.0003 inches or less, 0.0002 inches or less, 0.0001 inches or less).

A container often is non-porous, and generally does not permit intrusion of air or water. In contrast to a non-porous container, a container manufactured from a paper product (e.g., cardboard), and optionally shrink wrapped, generally is porous and not non-porous. A non-porous container member has about the same non-porous properties of a corresponding container member manufactured from polyethylene terephthalate (PET) and having a substantially uniform wall thickness of about 0.002 inches to about 0.10 inches (e.g., about 0.003 inches, 0.004 inches, 0.005 inches, 0.006 inches, 0.007 inches, 0.008 inches, 0.009 inches, 0.010 inches, 0.015 inches, 0.020 inches, 0.025 inches, 0.030 inches, 0.035 inches, 0.040 inches, 0.045 inches, 0.050 inches, 0.055 inches, 0.060 inches, 0.065 inches, 0.070 inches, 0.075 inches, 0.080 inches, 0.085 inches, 0.090 inches, 0.095 inches).

A container member that is transparent, or that includes one or more transparent portions, has about the same transparency of a corresponding container member manufactured from PET having a substantially uniform wall thickness of about 0.002 inches to about 0.10 inches (e.g., about 0.003 inches, 0.004 inches, 0.005 inches, 0.006 inches, 0.007 inches, 0.008 inches, 0.009 inches, 0.010 inches, 0.015 inches, 0.020 inches, 0.025 inches, 0.030 inches, 0.035 inches, 0.040 inches, 0.045 inches, 0.050 inches, 0.055 inches, 0.060 inches, 0.065 inches, 0.070 inches, 0.075 inches, 0.080 inches, 0.085 inches, 0.090 inches, 0.095 inches).

A container member that is translucent, or that includes one or more translucent portions, transmits less light, and/or transmits fewer wavelengths of light, from the exterior to the interior, compared to a corresponding container member manufactured from PET having a substantially uniform wall thickness of about 0.002 inches to about 0.10 inches (e.g., about 0.003 inches, 0.004 inches, 0.005 inches, 0.006 inches, 0.007 inches, 0.008 inches, 0.009 inches, 0.010 inches, 0.015 inches, 0.020 inches, 0.025 inches, 0.030 inches, 0.035 inches, 0.040 inches, 0.045 inches, 0.050 inches, 0.055 inches, 0.060 inches, 0.065 inches, 0.070 inches, 0.075 inches, 0.080 inches, 0.085 inches, 0.090 inches, 0.095 inches).

A container can include any suitable number of container members suitable for containing multiple pipette tip racks. A container sometimes includes a proximal member, which typically functions as a lid, and distal member, which typically functions as a base, as described in further detail hereafter. A proximal member and distal member sometimes are separate, and sometimes are joined (e.g., joined by a tether or by one common side (e.g., clamshell configuration)).

### Proximal Member

In some embodiments, a proximal member includes proximal member sidewalls and a proximal member top panel (e.g., proximal member 141 illustrated in FIG. 11 and proximal member 241 illustrated in FIG. 22) having an interior and exterior surface. In some embodiments, a proximal member includes four proximal member sidewalls arranged in a substantially rectangular configuration. A proximal member sometimes includes two long sidewalls (e.g., sidewalls 146-2 illustrated in FIG. 3 and sidewalls 246 illustrated in FIG. 14) and two short sidewalls (e.g., sidewalls 147-2 illustrated in FIG. 3 and sidewalls 247 illustrated in FIG. 14), arranged in a substantially rectangular configuration. Proximal member sidewalls sometimes are connected by a proximal member side junction configured to connect two proximal member sidewalls. Sometimes a proximal member includes four proximal member side junctions (e.g., side junctions 279 illustrated in FIG. 14). A proximal member side junction can be of a suitable configuration, non-limiting examples of which include a 90 degree edge, curved edge, beveled edge, angled edge, the like or combinations thereof. Proximal member sidewalls and proximal member side junctions often are integrated with a proximal member top panel. Proximal member sidewalls and a proximal member top panel sometimes are substantially flat. In some embodiments, proximal member sidewalls are at a 90 degree angle relative to a proximal member top panel (e.g., top panel 245 illustrated in FIG. 14). In some embodiments, proximal member sidewalls are flared from the top panel to the opposite side of the sidewalls at an angle greater than 90 degrees relative to the proximal member top panel. In some embodiments flared sidewalls do not contact or minimally contact pipette tip racks contained in the interior of a non-porous container. Proximal member sidewalls sometimes are directly joined to a proximal member top panel, and sometimes are joined via a transition surface to a proximal member top panel (e.g., a curved transition surface as illustrated in FIG. 14, or a beveled or stepped transition surface).

In some embodiments, sidewalls of a proximal member are relatively shallow (e.g., proximal member 141 illustrated in FIG. 3). In some embodiments, sidewalls of a proximal member extend upward from the top panel (e.g., sidewalls 146-1 illustrated in FIG. 3). In some embodiments, sidewalls of a proximal member are relatively tall (e.g., proximal member 241 in FIG. 14). In some embodiments, the sidewalls of a proximal member extend downward from the top panel (e.g., sidewall 246 illustrated in FIG. 14). The height of proximal member sidewalls can depend on the size of the pipette tip racks (e.g., medium or tall) contained within a non-porous container and the size of the pipette tips in the racks. For example, the height of proximal member sidewalls of assembly embodiment 100 (containing medium racks with pipette tips that can handle a volume of about 1 to about 300 microliters) is less than the height of proximal member sidewalls of assembly embodiment 200 (containing relatively tall racks with pipette tips that can handle volumes from about 1000 to about 1300 microliters).

In some embodiments, a proximal member includes (i) sidewalls that include no vertically disposed ribs and no transversely disposed ribs, and/or (ii) a top panel that includes no horizontally disposed ribs and no transversely disposed ribs (e.g., proximal member 141 illustrated in FIG. 3). In some embodiments, a proximal member includes (i) sidewalls that include vertically disposed ribs and/or transversely disposed ribs, and/or (ii) a top panel that includes horizontally disposed ribs and/or transversely disposed ribs (e.g., proximal member 241 illustrated in FIG. 14), as addressed herein. A rib extending from a distal portion of a sidewall to a proximal portion of a sidewall along axis 302 (shown in FIG. 1 and FIG. 12), where the sidewall is flared from the bottom panel of a distal member or is flared from a top panel of a proximal member, is referred to herein as “vertically disposed” as it extends in the same direction as vertical axis 302. In some embodiments, sidewalls contain one or more ribs and a top panel does not contain ribs, sometimes sidewalls do not contain ribs and a top panel contains one or more ribs, and sometimes sidewalls and a top panel contain one or more ribs. In certain embodiments, all sidewalls contain one or more ribs, and sometimes one, two or three sidewalls contain one or more ribs.

### Distal Member

In some embodiments, a distal member includes distal member sidewalls and a distal member bottom panel (e.g., bottom panel 153 in FIG. 2 and bottom panel 253 in FIG. 13) having an interior and exterior surface. In some embodiments, a distal member includes four distal member sidewalls arranged in a substantially rectangular configuration. A distal member sometimes includes two long sidewalls (e.g., relatively longer sidewalls 151 illustrated in FIG. 3 and relatively longer sidewalls 251 illustrated in FIG. 14) and two short sidewalls (e.g., relatively shorter sidewalls 152 illustrated in FIG. 3 and relatively short sidewalls 252 illustrated in FIG. 14) arranged in a substantially rectangular configuration. Distal member sidewalls sometimes are connected by a distal member side junction configured to connect two proximal member sidewalls. Sometimes a distal member includes four distal member side junctions (e.g., side junctions 279 illustrated in FIG. 14). A distal member side junction can be of a suitable configuration, non-limiting examples of which include a 90 degree edge, curved edge, beveled edge, angled edge, the like or combinations thereof. Distal member sidewalls and distal member side junctions often are integrated with a distal member bottom panel. Distal member sidewalls and a distal member bottom panel sometimes are substantially flat. In some embodiments, distal member sidewalls are at a 90 degree angle relative to a distal member bottom panel. In some embodiments, distal member sidewalls are flared from the bottom panel to the opposite side of the sidewalls at an angle greater than 90 degrees relative to a distal member bottom panel. In some embodiments flared sidewalls do not contact or minimally contact pipette tip racks contained in the interior of a non-porous container.

In some embodiments, a distal member includes (i) sidewalls that include no vertically disposed ribs and no transversely disposed ribs, and/or (ii) a bottom panel that includes no horizontally disposed ribs and no transversely disposed ribs. In some embodiments, a distal member includes (i) sidewalls that include vertically disposed ribs and/or transversely disposed ribs, and/or (ii) a bottom panel that includes horizontally disposed ribs and/or transversely disposed ribs (e.g., distal member 150 illustrated in FIG. 3 and distal member 250 illustrated in FIG. 14), as addressed herein. In some embodiments, sidewalls include one or more ribs and a bottom panel does not contain ribs, sometimes sidewalls do not include ribs and a bottom panel includes one or more ribs, and sometimes sidewalls and the bottom panel include one or more ribs. In certain embodiments, all sidewalls include one or more ribs, and sometimes one, two or three sidewalls include one or more ribs.

A proximal member often is configured to reversibly mate with a distal member, sometimes in sealing attachment. A proximal member can be sealingly mated to a distal member in any suitable manner or configuration that allows for attachment and detachment. In some embodiments, a proximal member can be attached and detached from a distal member multiple times. A proximal member sometimes is directly mated to a distal member by a compression fit or interference fit (e.g., a snap interference fit, friction interference fit and the like), for example. In certain embodiments, a proximal member and the distal member are configured to form an airtight seal when the proximal member is attached to the distal member. Certain proximal member embodiments include one or more components that directly mate with and seal with one or more components of a distal member. A proximal member, or portions thereof, sometimes includes a structure configured to join to a counterpart structure of a distal member. Such a structure in a proximal member sometimes is a lip, flange and/or a ridge, and such a counterpart structure in the distal member sometimes independently is a lip, flange and/or a ridge. In certain embodiments, such a structure in a proximal member is a flange and a counterpart structure in the distal member is a counterpart flange configured to join to the flange of the proximal member.

A flange of a proximal member and/or a distal member sometimes is embossed, sometimes is raised and sometimes includes a region that extends upward. A flange and optional lip region may extend continuously around the perimeter of certain proximal member embodiments and certain distal member embodiments. A flange may include any suitable shape or configuration, and sometimes is S-shaped, V-shaped, J-shaped and U-shaped, upwards or inverted shape for example.

In some embodiments, a flange is disposed around the perimeter of a proximal member (e.g., flange 142 illustrated in FIG. 8). In some embodiments, a lip feature is disposed around a flange (e.g., lip 143 illustrated in FIG. 8). A flange disposed on a proximal member sometimes includes at least one sidewall and a rim or step (e.g., flange sidewall 142-2 and flange rim 142-4 illustrated in FIG. 3). In some embodiments, a flange of a proximal member and/or distal member can include one or more horizontally-disposed bosses forming tiers or steps, which can enhance structural rigidity of the member (e.g., flange sidewalls 142-1 and 142-2 joined by flange step 142-3, flange sidewalls 142-5 and 142-6 joined by flange step 142-7, and flange sidewalls 142-1 and 142-5 joined by proximal rim 142-4, as illustrated in FIG. 3 and FIG. 8 for proximal member 141). A proximal member and/or distal member sometimes includes at least one tab (e.g., tab 149 illustrated in FIG. 3 and FIG. 7), which sometimes is disposed on a lip and sometimes extends beyond a lip. A tab often is positioned at one or more corners of a flange.

In some embodiments, a flange is disposed on a lower or distal surface of proximal member sidewalls and sometimes around the perimeter of the proximal member (e.g., flange 242 illustrated in FIG. 14). In some embodiments, such a flange includes a lip disposed around the flange perimeter (e.g., lip 243 illustrated in FIG. 14). A flange disposed on such a proximal member embodiment sometimes includes at least one sidewall and a rim or step (e.g., flange sidewall 242-1 and flange step 242-2 illustrated in FIG. 14). In some embodiments, such a flange can include one or more horizontally-disposed bosses forming tiers or steps. Certain of such proximal member embodiments sometimes include at least one tab (e.g., tab 249 illustrated in FIG. 14), which sometimes is disposed on a lip, sometimes extends beyond a lip, and sometimes is positioned at one or more corners of proximal member flange.

In some embodiments, a flange is disposed on an upper or proximal surface of distal member sidewalls and sometimes around the perimeter of a distal member (e.g., flange 154 illustrated in FIG. 3 and flange 254 illustrated in FIG. 14). In some embodiments, a lip feature is disposed around a flange of a distal member (e.g., lip 155 illustrated in FIG. 3 and lip 255 illustrated in FIG. 14). A flange disposed on a distal member sometimes includes at least one sidewall and a rim (e.g., flange sidewall 154-1 and flange rim 154-2 illustrated in FIG. 3 and flange sidewall 254-1 and flange rim 254-2 illustrated in FIG. 14).

In certain embodiments, a flange of a proximal member is sealingly joined to a flange of a distal member to form an interference fit. For example, the interior surface of flange sidewall 142-2 of proximal member 141 can be joined with, and interfere with, the exterior surface of flange sidewall 154-1 of distal member 150, as illustrated in FIG. 3. A seal between proximal member 141 and distal member 150 also can be in part formed by mating of the interior surface of flange step 142-3 with the exterior surface of flange rim 154-2. Also, for example, the interior surface of flange sidewall 242-1 of proximal member 241 can be joined with, and interfere with, the exterior surface of flange sidewall 254-1 of distal member 250, as illustrated in FIG. 14. A seal between proximal member 241 and distal member 250 also can be in part formed by mating of the interior surface of flange step 242-2 with the exterior surface of flange rim 254-2.

A proximal member or distal member that includes an inner sidewall and an outer sidewall sometimes includes one or more bosses projecting away from the center of the top panel or bottom panel. Such bosses can impart structural rigidity and integrity to the proximal member (e.g., bosses 148A and 148B illustrated in FIG. 10).

In some embodiments, a proximal member is sealingly attached to a distal member by electrostatic pressure or by an adhesive. An adhesive may be applied to the proximal member, or to the top of the distal member that joins with the proximal member, and may be applied at the time of manufacture. An adhesive may be mated with a removable backing that exposes the adhesive when removed before the proximal member is sealingly attached to the top of the distal member.

In some embodiments, panels of one or more sidewalls of a distal member include one or more indentations, projections or bosses that function as volumetric indicators (e.g., also referred to as “volumetric graduations”). Volumetric indicator 157 illustrated in FIG. 3 and volumetric indicator 257 illustrated in FIG. 14 are non-limiting examples of volumetric indicators. A volumetric indicator can be on an exterior surface and/or interior surface of one or more sidewalls. In some embodiments, a volumetric indicator is a mark on a sidewall for a predetermined volume of material contained within a distal member. For example, a volumetric indicator can serve as a mark for a predetermined volume of fluid or solid material (e.g., granular or broken solid material) contained in a distal member.

### Seal

In certain embodiments, a proximal member of a non-porous container is attached to a distal member to form a seal, where one or more pipette tip racks are contained within the interior of the container. A seal between a proximal member and a distal member can be made by any suitable means, including, but not limited to, those previously described. In certain embodiments, a seal is airtight. In certain embodiments, a non-porous container (e.g., container 140 illustrated in FIG. 11 or container 240 illustrated in FIG. 22), pipette tip racks (e.g., rack 105 illustrated in FIG. 3 or rack 205 illustrated in FIG. 14), or assemblies (e.g., assembly 100 illustrated in FIG. 1 or assembly 200 illustrated in FIG. 12) can be sterilized by a suitable method or treated using a suitable method whereby the interior of a non-porous container is essentially RNase free (e.g., non-limiting methodology for rendering an assembly essentially RNase free is known in the art and described herein). Individual components (e.g., pipette tip racks and/or containers) sometimes are sterilized separately prior to assembly to generate an assembly described herein, and sometimes an assembly is assembled and then sterilized. A seal between a proximal member and a distal member enables the interior of a non-porous container and the pipette tip racks contained within to remain sterile, essentially RNase free and in a moisture-controlled environment (protected from exposure to external moisture) during transit and storage.

### Pipette Tip Rack Configurations

A sidewall of a pipette tip rack can contact a sidewall of an adjacent pipette tip rack, thereby forming a horizontally-disposed layer of two or more pipette tip racks contained within a non-porous container in an assembly (e.g., FIG. 1 and FIG. 12). A layer of pipette tip racks can include adjacent racks in any suitable orientation relative to each other (e.g., long side/long side, short side/short side, long side/short side) that can be accommodated in a suitably-dimensioned non-porous container A layer of pipette tip racks can include 2, 3, 4, 5, 6, 7, 8, 9, 10 or more pipette tip racks. In certain embodiments, a layer includes 5 pipette tip racks.

In certain embodiments, pipette tip racks in one layer are in a stacked arrangement with pipette tip racks in another layer of pipette tip racks in a container. In certain stacked arrangement embodiments, a distal surface or portion thereof of a base of one pipette tip rack is in contact with the proximal surface or portion thereof of a lid of another pipette tip rack (e.g., FIG. 1 and FIG. 12). A container can include 2, 3, 4, 5, 6, 7, 8, 9, 10 or more pipette tip rack layers. In certain embodiments, a container includes two (2) pipette rack layers.

### Ribs

In certain embodiments, a non-porous container includes one or more ribs that can impart structural rigidity and integrity to a portion of the container. In certain embodiments, a rib is or includes a bossed projection, which sometimes projects away from the interior of a non-porous container. One or more sidewalls and/or a top panel of a proximal member sometimes include one or more ribs. In some embodiments, one or more sidewalls and/or a bottom panel of a distal member sometimes include one or more ribs. A proximal member and/or a distal member can include any suitable number of ribs (e.g., ribs disposed on a sidewall, a top panel, a bottom panel) and sometimes include about 2 ribs to about 20 ribs, about 2 ribs to about 10 ribs, or about 2 ribs to about 5 ribs (e.g., about 2, 3, 4, 5, 6, 7, 8, 9, 10, 11, 12, 13, 14, 15, 16, 17, 18, 19, 20 ribs). The number of ribs disposed on one sidewall, top panel or bottom panel sometimes is the same or different than the number of ribs disposed on another sidewall or panel of a non-porous container. A rib can be of any suitable geometry. Non-limiting examples of rib profiles include circular, oval, quadrilateral, square, rectangular, trapezoid, rhomboid, parallelogram, triangular, star, polygon, pentagon and hexagon. Ribs sometimes have beveled, curved or eased edges. Ribs disposed on a sidewall, top panel and/or bottom panel may be spaced equally (e.g., uniform distribution) and sometimes the distance between two ribs is different than the distance between two other ribs disposed on the same sidewall or panel (e.g., irregular distribution). Spacing between ribs disposed on one sidewall or panel sometimes is the same or different than spacing between ribs disposed on another sidewall or panel of a non-porous container.

In certain embodiments, a rib is located on a top and/or bottom panel and is a horizontally-disposed rib (e.g., rib 176 illustrated in FIG. 2 and rib 276 illustrated in FIG. 13). In some embodiments, a horizontally-disposed rib extends from one side of a top panel or bottom panel to the opposing side and opposing position of the top panel or bottom panel (e.g., the length or width of the panel). Sometimes a rib extends only a portion of the distance between opposing sides of a top panel or bottom panel (e.g., the length or width of the panel). In some embodiments, a rib located on a top panel or bottom panel extends between diagonal corners of a top or bottom panel and is a diagonally-disposed rib (e.g., rib 177 illustrated in FIG. 2 and rib 277 illustrated in FIG. 13). A top panel of a proximal member and/or a bottom panel of a distal member sometimes includes two or more rib types (i.e., horizontally-disposed ribs, diagonally-disposed ribs), and ribs of one type sometimes intersect with ribs of another type.

In certain embodiments, a rib is located on a sidewall of a proximal member or a distal member, extends across all or a portion of the height of a sidewall and is a vertically-disposed rib (e.g., rib 178 illustrated in FIG. 3. and rib 278 illustrated in FIG. 14). A sidewall of a proximal member or a distal member can include one or more diagonally-disposed ribs traversing the entire width of the sidewall or a portion thereof, and optionally, may include one or more horizontally-disposed ribs traversing the entire height of the sidewall or a portion thereof. A sidewall of a proximal member or distal member sometimes includes two or more rib types (i.e., vertically-disposed ribs, horizontally-disposed ribs, diagonally-disposed ribs), and ribs of one type sometimes intersect with ribs of another type. A proximal member of a non-porous container configured to contain medium size pipette tip racks sometimes does not include vertically-disposed ribs or diagonally-disposed ribs, and sometimes includes one or more horizontally-disposed bosses or ribs (e.g., flange sidewalls 142-1 and 142-2).

In certain embodiments, a rib is located between adjacent distal member sidewalls or adjacent proximal member sidewalls and is a sidewall junction rib (e.g., 179 in FIGS. 3 and 279 in FIGS. 14 and 21). A sidewall junction rib sometimes is located at a side junction or edge of a proximal member or a distal member.

In certain embodiments, vertically-disposed ribs disposed on a distal member sidewall transition into horizontally-disposed ribs disposed on a distal member bottom panel at a “rib vh transition” (e.g., transition 170 illustrated in FIG. 2. and transition 270 illustrated in FIG. 13). In certain embodiments, vertically-disposed ribs disposed on a proximal member sidewall transition into horizontally-disposed ribs disposed on a proximal member top panel at a “rib vh transition” (e.g., transition 270 illustrated for proximal member 241 in FIG. 14). In certain embodiments, sidewall junction ribs (e.g., rib 279 illustrated in FIG. 14) transition into diagonally-disposed ribs on a distal member bottom panel at a sidewall junction rib transition (e.g., transition 180 illustrated in FIG. 2 and transition 280 illustrated in FIG. 13). In certain embodiments, sidewall junction ribs (e.g., rib 279 illustrated in FIG. 14) transition into diagonally-disposed ribs on a proximal member top panel at a sidewall junction rib transition (e.g., transition 280 illustrated in FIG. 14). In certain embodiments, horizontally-disposed ribs and diagonally-disposed ribs of a distal member bottom panel intersect. In certain embodiments, horizontally-disposed ribs and diagonally-disposed ribs of a proximal member panel intersect. In certain embodiments, horizontally-disposed ribs (traversing the length of a non-porous container member) intersect with diagonally-disposed ribs (traversing the width of a non-porous container member) of a distal member bottom panel. In certain embodiments, horizontally-disposed ribs (traversing the length of a non-porous container member) intersect with diagonally-disposed ribs (traversing the width of a non-porous container member) of a proximal member top panel.

In some embodiments, one or more side panels are located between vertically-disposed ribs disposed on a sidewall of a proximal member (e.g., side panel 244 illustrated in FIG. 21). In some embodiments, one or more side panels are located between vertically-disposed ribs of a sidewall of a distal member (e.g., side panel 158 illustrated in FIG. 3 and side panel 258 illustrated in FIG. 14). In some embodiments, a side panel positioned between two vertically-disposed ribs is partitioned into adjacent vertical sections recessed relative to an adjoining section, thereby forming tiered panels with one or more undercuts (e.g., undercut 159 illustrated in FIG. 3 and undercut 259 illustrated in FIG. 14).

### Damage Prevention Features

In certain embodiments, a non-porous container includes one or more features configured to protect pipette tip racks contained within the container from physical damage (i.e., features that reduce probability of damage to contained pipette tip racks). One approach for incorporating enhanced structural features is inclusion of ribs (e.g., one or more rib types chosen from diagonally-disposed ribs, horizontally-disposed ribs, vertically-disposed ribs, transition ribs, sidewall transition ribs) on one or more sidewalls and/or top panel of a proximal member and/or on one or more sidewalls and/or bottom panel of a distal member. Ribs can impart structural rigidity and integrity to a non-porous container member, thereby reducing the likelihood of deformation or reducing deformation of the container member when it is exposed to an impact force.

Damage to a non-porous container often occurs at the corners and edges. Embodiments in which one or more diagonally-disposed ribs are included on a proximal member top panel and/or a distal member bottom panel, with or without one or more sidewall junction ribs that transition into the one or more diagonally-disposed ribs, can enhance structural rigidity and integrity in these locations. Non-limiting examples of such rib configurations include diagonally-disposed ribs 277, transition 280, and sidewall junction ribs 279 illustrated in FIG. 13 for a distal member and illustrated in FIG. 21 for a proximal member.

In some embodiments, a proximal member includes features that impart structural rigidity, including without limitation, (i) vertically-disposed ribs on a proximal member sidewall (e.g., vertically-disposed ribs 278 on sidewalls 256 and vertically-disposed ribs 248 on sidewalls 247 illustrated in FIG. 21), and/or (ii) horizontally-disposed ribs disposed on the proximal member top panel, which (1) can extend from two shorter sidewalls (e.g., 247) or two longer sidewalls (e.g., 246) or a portion thereof (e.g., horizontally-disposed ribs 277 illustrated in FIG. 21), and/or (2) sometimes intersect with diagonally-disposed ribs when the latter are present. In some embodiments, a distal member includes features that impart structural rigidity, including without limitation, (i) vertically-disposed ribs, which sometimes are located on shorter sidewalls (e.g., sidewalls 152 illustrated in FIG. 3) and sometimes are located on longer sidewalls (e.g., sidewalls 151 illustrated in FIG. 3); and/or (ii) panel members (e.g., panel members 158), which sometimes are located on shorter sidewalls (e.g., sidewalls 152 illustrated in FIG. 3), sometimes are located on longer sidewalls (e.g., sidewalls 151 illustrated in FIG. 3), sometimes are located between vertically-disposed ribs (e.g., located between ribs 178 illustrated in FIG. 3), and/or sometimes are disposed in a series of adjacent vertically-disposed sections each separated by an undercut (e.g., undercut 159 illustrated in FIG. 3).

In certain embodiments, a proximal member does not include diagonally-disposed ribs or vertically-disposed ribs on sidewalls or a top panel. A proximal member can include other features that impart structural rigidity, including without limitation, (i) a flange that contains horizontally-disposed bossed members (e.g., flange sidewalls 142-1 and 142-2 joined by flange step 142-3, flange sidewalls 142-5 and 142-6 joined by flange step 142-7, and flange sidewalls 142-1 and 142-5 joined by proximal rim 142-4, as illustrated in FIG. 3 and FIG. 8); and/or (ii) a flange that contains one or more bosses disposed on one or more sidewalls and/or sidewall junctions of a flange, which bosses sometimes are disposed on an inner sidewall of a flange and sometimes protrude away from the center of the proximal member top panel, for embodiments in which a flange includes an inner sidewall and an exterior sidewall (e.g., bosses 148A and 148B illustrated in FIG. 3).

Another approach to reducing the likelihood of damage to pipette tip racks when a container is exposed to an impact force, is inclusion of a space or void between the exterior surface of pipette tip racks and the interior surface of adjacent sidewalls of the container. Inclusion of a space or void provides for a “crumple zone” that permits deformation of a container sidewall in response to an impact force without the interior surface of the deformed sidewall contacting the exterior surface of an adjacent pipette tip rack. Non-limiting approaches to incorporate such a void include (i) incorporation of one or more bossed sidewall junction ribs, which bossed ribs project away from the container interior (e.g., sidewall junction rib 179 illustrated in FIG. 3 and sidewall junction rib 279 illustrated in FIG. 14), and/or (ii) incorporation of flared sidewalls, flaring from a proximal member top panel (i.e., at an angle greater than 90 degrees relative to the top panel), and/or flaring from a distal member bottom panel (i.e., at an angle greater than 90 degrees relative to the bottom panel). Non-limiting examples of voids that can serve as crumple zones are illustrated as regions 182A and 182B in FIG. 9 for assembly embodiment 100, which voids separate interior sidewalls and edges of the container from adjacent exterior surfaces of pipette tip racks. Inclusion of a space or void can be incorporated with or without enhanced structural features described above.

### Multiple Views

Provided herein are pipette tip rack assemblies with transparent or translucent sidewalls and panels that provide a viewer several different views of pipette tip racks or portions thereof, and/or pipette tips in the racks contained within a non-porous container. Views can depend on (i) size of the pipette tip racks within a non-porous container, (ii) size of the pipette tips in the racks, (iii) dimensions of the proximal and distal members, and/or (iv) whether the racks and pipette tips are viewed through a long or a short sidewall of a proximal member, or a long or a short sidewall of a distal member, or a top panel of a proximal member. Views also can depend on whether a rack lid and base are transparent or translucent or whether only the rack lid is transparent or translucent.

In certain embodiments, a pipette tip rack lid is transparent or translucent and pipette tips within a rack are visible through a rack lid. In some embodiments, a proximal member of a non-porous container includes a transparent top panel and transparent sidewalls. In some embodiments, a proximal member of a non-porous container includes a translucent top panel and translucent sidewalls. In some embodiments, a distal member of a non-porous container includes transparent sidewalls. In some embodiments, a distal member of a non-porous container includes translucent sidewalls. In certain embodiments a distal member includes 2, 3 or 4 sidewalls that are transparent or translucent. In some embodiments, a distal member bottom panel can be transparent or translucent. In certain embodiments, a distal member includes four sidewalls that are transparent. In some embodiments, a proximal member includes a transparent top panel and transparent sidewalls, and a distal member includes four sidewalls that are transparent. In some embodiments, a proximal member includes a transparent top panel and transparent sidewalls, and a distal member includes four sidewalls that are transparent and a transparent bottom panel.

In certain embodiments, proximal members and distal members need not both be transparent or translucent (e.g., a proximal member may be opaque and a distal member may be transparent or translucent, or a distal member may be opaque and a proximal member may be transparent or translucent). In some embodiments, a proximal member can be transparent and a distal member can be translucent, and sometimes a proximal member can be translucent and a distal member can be transparent.

In certain embodiments, a pipette tip receptacle plate of a pipette tip rack is visible through a proximal member and/or distal member of a non-porous container. In certain embodiments, a receptacle plate is of a color that correlates with the size of the pipette tip that it contains. In certain embodiments, a color of a receptacle plate of a pipette tip rack contained within a non-porous container is visible through the proximal member and/or distal member, allowing for identification of the size of the pipette tips contained within the non-porous container (i.e., identification of the volumes of fluid the pipette tips can handle).

FIG. 3 and FIG. 14 show pipette tip rack bases that are solid. In some embodiments, pipette tip rack bases can be transparent or translucent which can result in more of a pipette tip being visible through sidewalls of the certain proximal members and/or distal members.

The following represent non-limiting viewing embodiments of pipette tip racks and pipette tips contained in a non-porous container as described. FIG. 1 shows pipette tip racks and pipette tips visible through a top panel of a proximal member, a distal member short sidewall and a distal member long sidewall. FIG. 4 and FIG. 5 show pipette tip racks and pipette tips visible through a distal member long sidewall 151. FIG. 6 shows pipette tip racks and pipette tips visible through a distal member short sidewall. FIG. 7 shows pipette tip racks and pipette tips visible through a top panel of a proximal member. FIG. 12 shows pipette tip racks and pipette tips visible through a top panel of a proximal member, a proximal member short sidewall, a proximal member long sidewall, a distal member short sidewall and a distal member long sidewall. FIG. 15 and FIG. 16 show pipette tip racks and pipette tips visible through a proximal member long sidewall 246 and a distal member long sidewall 251. FIG. 16 shows pipette tip racks and pipette tips visible through a proximal member short side wall 247 and a distal member short sidewalls 252. FIG. 17 shows pipette tip racks and pipette tips visible through a top panel of a proximal member.

### Use of Assemblies

Provided herein are methods of using a pipette tip rack assembly, which can include, obtaining a pipette tip rack assembly as described herein, separating the proximal member from the distal member of the non-porous container and disassociating at least one of the pipette tip racks from the proximal member and/or distal member. In some embodiments, the proximal member and the distal member of the non-porous container are unsealed and then sealed after disassociating at least one of the pipette tip racks from the proximal member and/or distal member. In some embodiments, at least one of the pipette tip racks is disassociated from the proximal member and/or distal member of the non-porous container under clean air conditions. Clean air conditions include without limitation use of a laminar airflow workstation, sterile hood workstation, a clean room, clean facility or other essentially sterile environment. In certain embodiments, clean air conditions include subjecting a pipette tip rack assembly to clean air conditions prior to separating the proximal and distal member, and joining the proximal and distal member under the clean air conditions.

In some embodiments, all of the pipette tip racks from the proximal member and/or the distal member of a non-porous container are disassociated from the non-porous container and the non-porous container is recycled. In some embodiments, all of the pipette tip racks from the proximal member and/or the distal member of the non-porous container are disassociated and one or more non-pipette tip rack items are introduced to and contained in the non-porous container. In certain embodiments, the proximal member and distal member are joined (e.g., sealed) after introducing the one or more non-pipette tip rack items into the non-porous container. In some embodiments, the proximal member and distal member are separated, one or more of the non-pipette tip rack items from the proximal member and/or distal member of the non-porous container are removed and the proximal member and distal member of the non-porous container are joined (e.g., sealed) after the item is obtained.

Also provided herein are methods of using a pipette tip rack assembly to inventory or identify pipette tip racks and or pipette tips contained in a sealed transparent or translucent non-porous container without the need to label the exterior of the non-porous container or open the non-porous container.

### Manufacturing Methods

Provided herein are methods of manufacturing a pipette tip rack assembly. In certain embodiments, the method includes associating a plurality of pipette tip racks with at least one member of a non-porous container and joining the proximal member to the distal member of the non-porous container, whereby the plurality of pipette tip racks are contained within the non-porous container. The distal member and proximal member sometimes are sealed to one another (e.g., an essentially airtight seal), and the proximal member and distal member of a non-porous container often are reversibly sealed. In some embodiments, prior to associating a plurality of pipette tip racks with at least one member of a non-porous container, the interior of the non-porous container is subjected to a process that renders it essentially RNase free. Any suitable process for rendering the interior of a container essentially RNase free may be utilized. Non-limiting examples of rendering a container member essentially RNase free include exposing the container member(s) and/or contents to radiation, heat (e.g., 180 degrees Celsius or greater for a sufficient period of time), denaturant (e.g., chloroform, diethyl pyrocarbonate (DEPC), hydrogen peroxide, sodium hydroxide) or combination thereof. In some embodiments, an interior of a non-porous container that has been rendered essentially RNase free is maintained RNase free when associating pipette tip racks with a member of the non-porous container using a suitable technique (e.g., associating a container member with contents in a laminar airflow workstation).

In some embodiments, a subset of the plurality of pipette tip racks placed in a non-porous container are in a stacked arrangement. In some embodiments, a distal surface of a rack base of one of the pipette tip racks is in contact with a proximal surface of a lid of another of the pipette tip racks.

Pipette tip rack assembly components (e.g. non-porous container proximal member and distal member) described herein may be manufactured by any suitable process. Non-limiting examples of manufacturing processes include thermoforming, vacuum forming, pressure forming, plug-assist forming, reverse-draw thermoforming, matched die forming, extrusion, casting and injection molding.

Pipette tip rack assembly components independently can include, and can be manufactured from, the same or different material. In some embodiments, all elements of a rack assembly component are manufactured from the same material. Some or all elements of a rack assembly component sometimes include, or are manufactured from, a suitable polymer or polymer mixture. Non-limiting examples of polymers include low density polyethylene (LDPE), high-density polyethylene (HDPE), polypropylene (PP), high impact polystyrene (HIPS), polyvinyl chloride

(PVC), polyethylene terephthalate (PET), amorphous polyethylene terephthalate (APET), polycarbonate (PC) and polyethylene (PE). One or more elements of a pipette tip rack assembly can include, or can be manufactured from, a recyclable material and/or degradable material (e.g., a bio-degradable material), non-limiting examples of which are disclosed in International Application no. PCT/US2009/063762 filed on Nov. 9, 2009 and published as WO 2010/054337 on May 14, 2010. In certain embodiments, a non-porous container proximal and distal members are manufactured from polyethylene terephthalate (PET) or a comparable recyclable material, whereby a non-porous container can be recycled. One or more elements of a pipette tip rack assembly, in some embodiments, include an anti-microbial agent, non-limiting examples of which are disclosed in International Application no. PCT/US2009/047541 filed on Jun. 16, 2009 and published as WO 2010/008737 on Jan. 10, 2010 (e.g., antimicrobial metal (e.g., silver)). A component of an assembly described herein can include a suitable elastomeric material (e.g., a flange of a container proximal member), which can provide for a seal between the proximal member and a distal member.

A container manufactured from a polymer often is inherently translucent or transparent. All portions of a container sometimes are translucent or transparent, and sometimes a subset of portions of a container are translucent or transparent and a subset of portions of a container are opaque. Translucent or transparent properties can be induced or altered, for example, by inclusion of one or more additives that alter transparency or opaqueness in response to various types of electromagnetic radiation. In some embodiments, a polymer used to manufacture a container can be colored or made to be colored.

An assembly component sometimes is manufactured by thermoforming process known in the art (e.g., container proximal member and/or distal member). In some embodiments, provided is a method for manufacturing a proximal member or distal member of a non-porous container that includes contacting a form with a plastic sheet under thermoforming conditions in which the plastic sheet is formed into the proximal member or distal member described herein. Also provided in certain embodiments is a form configured to form a proximal member or distal member described herein under thermoforming conditions. The form can include a metal, and sometimes is manufactured from a metal (e.g., a metal that includes aluminum, zinc, steel, a steel alloy or combination thereof). A plastic sheet sometimes includes or sometimes essentially is a polymer or polymer blend described herein (e.g., polyethylene terephthalate (PET) or amorphous polyethylene terephthalate (APET)). An assembly component often is formed as a unitary construct.

An assembly component sometimes is manufactured by an injection molding process known in the art (e.g., pipette tip, pipette tip rack component). Injection molding is a manufacturing process for producing objects from a thermoplastic or thermoplastic blend (e.g., nylon, polypropylene, polyethylene, polystyrene and the like, for example) or thermosetting plastic (e.g., epoxy and phenolics, for example) materials. A plastic material (e.g., a polymer material) of choice often is fed into a heated barrel, mixed, and forced into a mold cavity where it cools and hardens to the configuration of the mold cavity. The melted material sometimes is forced or injected into the mold cavity, through openings (e.g., a sprue), under pressure. A pressure injection method often ensures the complete filling of the mold with the melted plastic. After the mold cools, mold portions are separated, and the molded object is ejected.

A polymer with higher flow and lower viscosity sometimes is selected for use in injection molding processes. Non-limiting examples of polymers with higher flow and lower viscosity include any suitable moldable material having one or more of the following properties: a melt flow rate (230 degrees Celsius at 2.16 kg) of about 30 to about 75 grams per 10 minutes using an ASTM D 1238 test method; a tensile strength at yield of about 3900 to about 5000 pounds per square inch using an ASTM D 638 test method; a tensile elongation at yield of about 7 to about 14% using an

ASTM D 638 test method; a flexural modulus at 1% sectant of about 110,000 to about 240,000 pounds per square inch using an ASTM D 790 test method; a notched Izod impact strength (23 degrees Celsius) of about 0.4 to about 4.0 foot pounds per inch using an ASTM D 256 test method; and/or a heat deflection temperature (at 0.455 MPa) of about 160 degrees to about 250 degrees Fahrenheit using an ASTM D 648 test method. Non-limiting examples of materials that can be used include polypropylene, polystyrene, polyethylene, polycarbonate, the like, and mixtures thereof. In some embodiments, additional additives can be included in the polymer or mold to impart additional properties to the final product (e.g., anti-microbial, degradable, anti-static properties). An assembly component often is injection molded as a unitary construct.

A mold generally is configured to retain molten plastic in a geometry that yields the desired product upon cooling of the plastic. Injection molds sometimes are made of two or more parts. Molds typically are designed so that the molded part reliably remains on the ejector side of the mold after the mold opens, after cooling. The molded part may fall freely away from the mold when ejected from ejector side of the mold. In some embodiments, an ejector sleeve pushes the molded part from the ejector side of the mold.

Thus, an assembly component sometimes is manufactured by a method that includes: providing a mold configured to form features of the component described herein; introducing a moldable polymer mixture to the mold; curing the polymer mixture in the mold, thereby forming the component; and releasing the component from the mold. In certain embodiments, a method for manufacturing an assembly component described herein includes: contacting a mold having an interior cavity configured to mold a pipette tip rack assembly component described herein with a molten polymer; hardening the polymer in the mold, thereby forming the pipette tip rack assembly component in the mold; and ejecting the pipette tip rack assembly component from the mold. One or more or all elements of a pipette tip rack assembly component be molded as a single unit, or can be attached after individual elements are molded. A mold sometimes includes or is manufactured from a metal, which sometimes is or includes aluminum, zinc, steel or a steel alloy. A polymer utilized in a molding process sometimes is a polymer described herein. Also provided herein in certain embodiments is a mold for manufacturing an assembly component described herein by a molding process (e.g., injection molding process), which includes a body that forms exterior surfaces of the pipette tip rack assembly component and a member that forms interior surfaces of the pipette tip rack assembly component. A mold sometimes includes one or more core components that form interior surfaces of the pipette tip rack assembly component.

### Listing of Certain Embodiments

Provided hereafter is a listing of certain non-limiting examples of embodiments of the technology.

A1. A pipette tip rack assembly, comprising:
a plurality of pipette tip racks, each of which racks comprises:
   a rack base,
   a pipette tip receptacle plate in connection with the rack base comprising an array of bores,
   pipette tips, each of which pipette tips is inserted into each of the bores in the receptacle plate, and
   a transparent or translucent lid in connection with the rack base; and
a transparent or translucent non-porous container comprising a proximal member and a distal member, which proximal member and which distal member are sealed, wherein:
   the seal is essentially air-tight, and
   the plurality of pipette tip racks are contained within the non-porous container.

A2. The pipette tip rack assembly of embodiment Al, wherein a subset of the pipette tip racks in the non-porous container are in a stacked arrangement.

A3. The pipette tip rack assembly of embodiment A2, wherein a distal surface of a rack base of one of the pipette tip racks is in contact with a proximal surface of a lid of another of the pipette tip racks.

A3.1. The pipette tip rack assembly of embodiment A3, wherein the pipette tips are each configured to retain or emit a volume of fluid of about 300 microliters or less.

A3.2. The pipette tip rack assembly of embodiment A3, wherein the pipette tips are each configured to retain or emit a volume of fluid of about 1000 microliters to about 1300 microliters or less.

A4. The pipette tip rack assembly of any one of embodiments A1 to A3.2, wherein the proximal member and distal member of the non-porous container are reversibly sealed.

A4.1. The pipette tip rack assembly of embodiments A1 to A4, wherein the proximal member and distal member of the non-porous container are sealed by mating the proximal member and the distal member to one another.

A4.2. The pipette tip rack assembly of embodiments A1 to A4.1, wherein the proximal member and distal member of the non-porous container are sealed by an interference fit.

A5. The pipette tip rack assembly of any one of embodiments A1 to A4.2, wherein the interior of the non-porous container is essentially RNase free when the non-porous container is sealed.

A5.1. The pipette tip rack assembly of embodiment A5, wherein the interior of the non-porous container remains essentially RNase free as long as the non-porous container is sealed.

A5.2. The pipette tip rack assembly of any one of embodiments A1 to A5.1, wherein the interior of the non-porous container is an essentially moisture-controlled environment when the non-porous container is sealed.

A5.3. The pipette tip rack assembly of embodiment A5.2, wherein the interior of the non-porous container remains an essentially moisture-controlled environment as long as the non-porous container is sealed.

A5.4. The pipette tip rack assembly of any one of embodiments A1 to A5.3, wherein the interior of the non-porous container is an essentially sterile when the non-porous container is sealed.

A5.5. The pipette tip rack assembly of embodiment A5.4, wherein the interior of the non-porous container remains essentially sterile as long as the non-porous container is sealed.

A6. The pipette tip rack assembly of any one of embodiments A1 to A5.5, wherein the lid of the pipette tip rack is transparent.

A7. The pipette tip rack assembly of any one of embodiments A1 to A5.5, wherein the lid of the pipette tip rack is translucent.

A8. The pipette tip rack assembly of any one of embodiments A1 to A7, wherein pipette tips inserted into the bores of the receptacle plate are visible through the proximal member and/or the distal member of the non-porous container.

A8.1. The pipette tip rack assembly of any one of embodiments A1 to A7, wherein the receptacle plate of a pipette tip rack is visible through the proximal member and/or the distal member of the non-porous container.

A8.2. The pipette tip rack assembly of any one of embodiments A1 to A7, wherein pipette tip racks in the interior of the non-porous container are visible through the proximal member and/or the distal member of the non-porous container.

A9. The pipette tip rack assembly of any one of embodiments A1 to A8.2, wherein the distal member of the non-porous container comprises a bottom panel and sidewalls integrally connected to the bottom panel and to adjacent sidewalls.

A9.1. The pipette tip rack assembly of embodiment A9, wherein the sidewalls are flared from the bottom panel at an angle greater than 90 degrees relative to the bottom panel.

A10. The pipette tip rack assembly of any one of embodiments A1 to A9.1, wherein the proximal member is transparent and four sidewalls of the distal member are transparent.

A10.1. The pipette tip rack assembly of any one of embodiments A9 to A10, wherein the bottom panel is transparent.

A11. The pipette tip rack assembly of any one of embodiments A1 to A9, wherein the proximal member is translucent and four sidewalls and bottom panel of the distal member are translucent.

Al2. The pipette tip rack assembly of any one of embodiments A1 to A9, wherein the proximal member is transparent or translucent and four sidewalls of the distal member are transparent or translucent.

Al2.1. The pipette tip rack assembly of embodiment A12, wherein the bottom panel is transparent or translucent.

A13. The pipette tip rack assembly of any one of embodiments A1 to A12, where the rack base is transparent or translucent.

A14. The pipette tip rack assembly of any one of embodiments A1 to A13, wherein the container comprises a plastic.

A14.1. The pipette tip rack assembly of embodiment A14, wherein the container is manufactured from a plastic.

A14.2. The pipette tip rack assembly of embodiment A14, wherein of the plastic comprises a recyclable plastic.

A14.3. The pipette tip rack assembly of embodiment A14.2, wherein the recyclable plastic comprises polyethylene terephthalate (PET).

A15. The pipette tip rack assembly of any one of embodiments Al to A14.3, wherein the proximal member does not substantially overlap with the distal member.

A15. The pipette tip rack assembly of any one of embodiments A1 to A15, wherein the proximal member of the non-porous container comprises a top panel and sidewalls, wherein the top panel is integrally connected to adjacent sidewalls.

A16. The pipette tip rack assembly of embodiment A15, wherein the top panel does not comprise diagonally disposed ribs.

A16.1. The pipette tip rack assembly of embodiment A16, wherein the sidewalls of the proximal member comprise bosses.

A16.2. The pipette tip rack assembly of embodiment A16.1, wherein the proximal member comprises a boss forming a vertically-disposed sidewall junction rib disposed at an edge at which adjacent sidewalls join.

A17. The pipette tip rack assembly of any one of embodiments A1 to A15, wherein a proximal member top panel comprises diagonally-disposed ribs.

A18. The pipette rack assembly of embodiment A17, wherein: the proximal member comprises sidewalls, and the sidewalls comprise vertically-disposed ribs and transition ribs between the sidewalls.

A19. The pipette rack assembly of embodiment A17 or A18, wherein a proximal member top panel comprises horizontally-disposed ribs.

A20. The pipette rack assembly of embodiment A19, wherein a transition rib contacts a diagonally-disposed rib.

A20.1. The pipette rack assembly of embodiment A19, wherein a vertically-disposed rib contacts a horizontally-disposed rib.

A20.2. The pipette rack assembly of embodiment A18, wherein a horizontally-disposed rib contacts a diagonally-disposed rib.

A20.3. The pipette rack assembly of embodiment A18, wherein a horizontally-disposed rib contacts another horizontally-disposed rib.

A21. The pipette tip rack assembly of any one of embodiments A9 to A20.3, wherein the distal member bottom panel comprises diagonally-disposed ribs.

A22. The pipette rack assembly of embodiment A21, wherein a distal member bottom panel comprises horizontally-disposed ribs.

A23. The pipette rack assembly of embodiment A9 to A22, wherein the distal member sidewalls comprise vertically-disposed ribs and transition ribs between the sidewalls.

A24. The pipette rack assembly of embodiment A23, wherein a transition rib contacts a diagonally-disposed rib.

A24.1. The pipette rack assembly of embodiment A23, wherein a vertically-disposed rib contacts a horizontally-disposed rib.

A24.2. The pipette rack assembly of embodiment A22, wherein a horizontally-disposed rib contacts a diagonally-disposed rib.

A24.3. The pipette rack assembly of embodiment A22, wherein a horizontally-disposed rib contacts another horizontally-disposed rib.

A24.4. The pipette tip rack assembly of any one of embodiments A1 to A24.3, wherein:
the proximal member and/or the distal member comprises a boss forming a vertically-disposed sidewall junction rib located at an intersection of adjacent sidewalls; and
the interior surface of the sidewall junction rib is spaced from the exterior surface of an adjacent pipette tip rack.

B1. A method for manufacturing an assembly, comprising:
associating a plurality of pipette tip racks with at least one member of a transparent or translucent non-porous container, wherein:
   each of the racks comprises:
      a rack base,
      a pipette tip receptacle plate in connection with the rack base comprising an array of bores,
      pipette tips, each of which pipette tips is inserted into each of the bores in the receptacle plate, and
      a lid in connection with the rack base; and
   the non-porous container comprises a proximal member and a distal member; and sealing the proximal member and the distal member, wherein:
   the proximal member and the distal member are sealed by an essentially airtight seal, and
   the plurality of pipette tip racks are contained within the non-porous container in an assembly of any one of embodiments A1-A24.4.

B2. The method of embodiment B1, wherein the lid in connection with the rack base is transparent or translucent.

B3. The method of embodiment B1 or B2, wherein prior to associating a plurality of pipette tip racks with at least one member of a transparent or translucent non-porous container, the interior of the non-porous container is essentially RNase free and essentially sterile.

B4. The method of any one of embodiments B1 to B3, wherein a subset of the plurality of pipette tip racks in the non-porous container are in a stacked arrangement.

B5. The method of embodiment B4, wherein a distal surface of a rack base of one of the pipette tip racks is in contact with a proximal surface of a lid of another of the pipette tip racks.

B6. The method of any one of embodiments B1 to B5, wherein the proximal member and distal member of the non-porous container are reversibly sealed.

B7. A method for manufacturing a proximal member or distal member of a non-porous container, comprising:
contacting a form configured to form a proximal member or distal member of an assembly of any one of embodiments A1-A24.4 with a plastic sheet, and
forming under thermoforming conditions the plastic sheet into the proximal member or distal member of an assembly of any one of embodiments A1-A24.4.

B8. The method of embodiment B7, wherein the form comprises a metal.

B9. The method of embodiment B8, wherein the form is manufactured from a metal.

B10. The method of embodiment B8 or B9, wherein the metal is chosen from aluminum, zinc, steel and a steel alloy.

B11. The method of any one of embodiments B7 to B10, wherein the plastic sheet comprises or consists of polyethylene terephthalate (PET) or amorphous polyethylene terephthalate (APET).

B12. A form configured to manufacture a proximal member or distal member of an assembly of any one of embodiments A1-A24.4 by a thermoforming process.

B13. The form of embodiment B12, wherein the form comprises a metal.

B14. The form of embodiment B13, wherein the form is manufactured from a metal.

B15. The form of embodiment B13 or B14, wherein the metal is chosen from aluminum, zinc, steel and a steel alloy.

C1. A method for using an assembly, comprising:
providing an assembly of any one of embodiments A1-A24.1;
disassociating the proximal member from the distal member; and
removing at least one of the pipette tip racks from the proximal member and/or distal member of the non-porous container.

C2. The method of embodiment C1, comprising removing all of the pipette tip racks from the proximal member and/or the distal member of the non-porous container.

C3. The method of embodiment C1 or C2, comprising inserting one or more non-pipette tip rack items in the proximal member and/or distal member of the non-porous container.

C4. The method of any one of embodiments C1-03, comprising sealing the proximal member and distal member of the non-porous container.

C5. The method of any one of embodiments C1-04, wherein disassociating and/or the removing is under clean air conditions.

C6. The method of embodiment C5, wherein the clean air conditions are laminar airflow conditions.

D1. A method of inventorying or identifying pipette tip racks and/or pipette tips of an assembly of any one of embodiments A1-A24.4, comprising: viewing the pipette tips and/or pipette tip racks through one or more surfaces of a proximal member and/or distal member, without disassociating the proximal member and the distal member to view the interior of the non-porous container.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the technology. Although the technology has been described in substantial detail with reference to one or more specific embodiments, those of ordinary skill in the art will recognize that changes may be made to the embodiments specifically disclosed in this application, yet these modifications and improvements are within the scope and spirit of the technology.

The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a pipette tip” can mean one or more pipette tips) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” refers to about 1, about 2 and about 3). For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). Thus, it should be understood that although the present technology has been specifically disclosed by representative embodiments and optional features, modification and variation of the concepts herein disclosed may be resorted to by those skilled in the art, and such modifications and variations are considered within the scope of this technology.

Certain embodiments of the technology are set forth in the claims that follow.

1-73. (canceled)

74. A pipette tip rack assembly, comprising:
a plurality of pipette tip racks, each of which racks comprises:
a rack base,
a pipette tip receptacle plate in connection with the rack base comprising an array of bores,
pipette tips, each of which pipette tips is inserted into one of each of the bores in the receptacle plate, and
a transparent or translucent lid in connection with the rack base; and
a transparent or translucent non-porous container comprising a proximal member and a distal member, which proximal member and which distal member are sealed, wherein:
the seal is essentially air-tight, and
the plurality of pipette tip racks are contained within the non-porous container.

75. The pipette tip rack assembly of claim 74, wherein a subset of the pipette tip racks in the non-porous container are in a stacked arrangement, wherein a distal surface of the rack base of one of the pipette tip racks is in contact with a proximal surface of a lid of another of the pipette tip racks.

76. The pipette tip rack assembly of claim 74, wherein the pipette tips are each configured to retain or emit a volume of fluid of about 300 microliters or less.

77. The pipette tip rack assembly of claim 74, wherein the pipette tips are each configured to retain or emit a volume of fluid of about 1000 microliters to about 1300 microliters or less.

78. The pipette tip rack assembly of claim 74, wherein the proximal member and distal member of the non-porous container are reversibly sealed.

79. The pipette tip rack assembly of claim 74, wherein the interior of the non-porous container is essentially RNase free when the non-porous container is sealed.

80. The pipette tip rack assembly of claim 74, wherein the interior of the non-porous container is an essentially moisture-controlled environment when the non-porous container is sealed.

81. The pipette tip rack assembly of claim 74, wherein the interior of the non-porous container is an essentially sterile when the non-porous container is sealed.

82. The pipette tip rack assembly of claim 74, wherein one or more of the pipette tip racks are sterile.

83. The pipette tip rack assembly of claim 74, wherein one or more of the rack bases are transparent or translucent.

84. The pipette tip rack assembly of claim 74, wherein pipette tips, one or more receptacle plates or one or more pipette tip racks in the interior of the non-porous container are visible through the proximal member and/or the distal member of the non-porous container.

85. The pipette tip rack assembly of claim 74, wherein the distal member of the non-porous container comprises a bottom panel and sidewalls integrally connected to the bottom panel and to adjacent sidewalls.

86. The pipette tip rack assembly of claim 85, wherein the proximal member is transparent or translucent and the sidewalls and bottom panel of the distal member are transparent or translucent.

87. The pipette tip rack assembly of claim 74, wherein the container comprises a plastic.

88. The pipette tip rack assembly of claim 87, wherein of the plastic comprises a recyclable plastic.

89. The pipette tip rack assembly of claim 74, wherein the proximal member of the non-porous container comprises a top panel and sidewalls, wherein the top panel is integrally connected to adjacent sidewalls.

90. The pipette tip rack assembly of claim 74, wherein the proximal member and/or the distal member comprise ribs.

91. A method for manufacturing an assembly, comprising:
providing a transparent or translucent non-porous container comprising a proximal member and a distal member;
providing a plurality of pipette tip racks, wherein each of the racks comprises:
a rack base,
a pipette tip receptacle plate in connection with the rack base comprising an array of bores,
pipette tips, each of which pipette tips is inserted into one of each of the bores in the receptacle plate, and
a transparent or translucent lid in connection with the rack base;
associating the plurality of pipette tip racks with at least the proximal member or the distal member of the container; and
sealing the proximal member and the distal member, wherein:
the proximal member and the distal member are sealed by an essentially airtight seal, and
the plurality of pipette tip racks are contained within the non-porous container in an assembly.

92. A method for using an assembly, comprising:
providing an assembly of claim 74;
disassociating the proximal member from the distal member; and
removing at least one of the pipette tip racks from the proximal member and/or distal member of the non-porous container.

93. The method of claim 92, wherein the disassociating and/or the removing is under clean air conditions.
